(19) United States
(12) Patent Application Publication
(10) Pub. No.: US 2024/0230826 A1
(43) Pub. Date: Jul. 11, 2024

(54) Positioning based on Non-Cellular Ranging Signals and Cellular Radio Access Technology (RAT) Signals

(71) Applicant: Telefonaktiebolaget LM Ericsson (publ), Stockholm (SE)

(72) Inventors: Satyam Dwivedi, Solna (SE); Ritesh Shreevastav, Upplands Väsby (SE); Åke Busin, Sollentuna (SE)

(21) Appl. No.: 18/560,274

(22) PCT Filed: Jun. 17, 2022
(86) PCT No.: PCT/SE2022/050600

§ 371 Date: Nov. 10, 2023

Related U.S. Application Data
(60) Provisional application No. 63/211,748, filed on Jun. 17, 2021.

(51) Int. Cl. G01S 5/02; G01S 5/00

(52) U.S. Cl. CPC G01S 5/0236; G01S 5/0036; G01S 5/0263; G01S 2205/008

(57) ABSTRACT

Embodiments include methods for a network node or function (NNF) configured to facilitate positioning of a user equipment (UE) based on measurements of cellular radio access technology (RAT) signals and of non-cellular ranging (e.g., UWB) signals. Such methods include sending the following information to the UE: first assistance data that identifies one or more non-cellular ranging devices associated with a wireless network, and second assistance data that identifies one or more cellular RAT transmitters of the wireless network. Such methods include receiving the following information from the UE: first measurements of non-cellular ranging signals transmitted by the one or more non-cellular ranging devices identified by the first assistance data, and second measurements of cellular signals transmitted by the one or more cellular RAT transmitters identified by the second assistance data. Other embodiments include complementary methods for a UE and for a non-cellular ranging device.

### TECHNICAL FIELD

The present disclosure relates generally to wireless networks and more specifically to positioning of user equipment (UE) in wireless networks based on measurements of non-cellular ranging signals (e.g., UWB signals) and of cellular radio access technology (RAT) signals.

### BACKGROUND

Long-Term Evolution (LTE) is an umbrella term for so-called fourth-generation (4G) radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

Currently the fifth generation (“5G”) of cellular systems, also referred to as New Radio (NR), is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases. NR was initially specified in 3GPP Release 15 (Rel-15) and continues to evolve through subsequent releases, such as Rel-16 and Rel-17.

5G/NR technology shares many similarities with LTE. For example, NR uses CP-OFDM (Cyclic Prefix Orthogonal Frequency Division Multiplexing) in the downlink (DL) from network to user equipment (UE), and both CP-OFDM and DFT-spread OFDM (DFT-S-OFDM) in the uplink (UL) from UE to network. As another example, NR DL and UL time-domain physical resources are organized into equal-sized 1-ms subframes. A subframe is further divided into multiple slots of equal duration, with each slot including multiple OFDM-based symbols. However, time-frequency resources can be configured much more flexibly for an NR cell than for an LTE cell. For example, instead of a fixed 15-kHz OFDM sub-carrier spacing (SCS) as in LTE, NR SCS can range from 15 to 240 kHz, with even greater SCS considered for future NR releases.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc. In general, SSB is available to all UEs regardless of the state of their connection with the network, while other RS (e.g., CSI-RS, DM-RS, PTRS) are associated with specific UEs that have a network connection.

3GPP standards provide various ways for positioning (e.g., determining the position of, locating, and/or determining the location of) UEs operating in LTE networks. In general, an LTE positioning node (referred to as “E-SMLC” or “location server”) configures the target device (e.g., UE), an eNB, or a radio network node dedicated for positioning measurements (e.g., a “location measurement unit” or “LMU”) to perform one or more positioning measurements according to one or more positioning methods. For example, the positioning measurements can include timing (and/or timing difference) measurements on UE, network, and/or satellite transmissions. The positioning measurements are used by the target device, the measuring node, and/or the positioning node to determine the location of the target device. UE positioning is also expected to be an important feature for NR networks, and may include additional positioning techniques, use cases, scenarios, and/or applications beyond those prevalent in LTE.

3GPP Rel-15 introduced positioning based on motion (or movement) measurements by a UE, e.g., based on a motion sensor in the UE. These movement measurements typically include displacement results estimated as an ordered series of points. Motion-sensor measurements can be combined with other positioning measurements to create hybrid positioning methods. For example, motion sensor measurements can be combined with assisted global navigation satellite system (A-GNSS) measurements to locate a UE based on relative positioning. When GNSS signals are temporarily unavailable to the UE (e.g., in an underground tunnel), motion sensor measurements can be used to continue tracking the UE relative to the UE's last valid absolute position based on GNSS (e.g., before entering the tunnel). Motion-sensor measurements can also be combined with UE measurements of signals transmitted by an NR network, such as PRS mentioned above.

Ultra-wideband (UWB) is a non-cellular radio technology that uses a very low energy level for short-range, high-bandwidth communications. UWB's very narrow time-domain pulses spread energy over a large portion of the radio spectrum, i.e., an “ultra-wide bandwidth”. UWB has traditional applications in radar imaging but has more recently been used for short-range communications and high-precision ranging. For example, UWB can provide indoor localization of devices.

### SUMMARY

It is expected that many UEs will include non-cellular ranging technologies (e.g., UWB) in the future. However, there are various problems, issues, and/or difficulties that must be addressed to utilize non-cellular ranging technologies together with other positioning technologies (e.g., based on cellular or GNSS signals) that are currently standardized by 3GPP.

Embodiments of the present disclosure provide specific improvements to positioning of UEs operating in a wireless network, such as by facilitating solutions to overcome exemplary problems summarized above and described in more detail below.

Some embodiments of the present disclosure include methods (e.g., procedures) for a network node or function (NNF) configured to facilitate positioning of a UE based on measurements of cellular radio access technology (RAT) signals and of non-cellular ranging signals.

These exemplary methods can include sending the following information to the UE: first assistance data that identifies one or more non-cellular ranging devices associated with a wireless network, and second assistance data that identifies one or more cellular RAT transmitters of the wireless network. These exemplary methods can also include receiving the following information from the UE: first measurements of non-cellular ranging signals (e.g., UWB signals) transmitted by the one or more non-cellular ranging devices identified by the first assistance data, and second measurements of cellular signals transmitted by the one or more cellular RAT transmitters identified by the second assistance data.

In some embodiments, the second assistance data can be sent after receiving the first measurements and these exemplary methods can also include determining the second assistance data based on the received first measurements and the first assistance data. In other embodiments, the first assistance data can be sent after receiving the second measurements and these exemplary methods can also include determining the first assistance data based on the received second measurements and the second assistance data.

In some embodiments, these exemplary methods can also include sending to the UE a request for the UE's non-cellular positioning capabilities and receiving from the UE a response indicating the UE's non-cellular positioning capabilities of the UE. In such case, the first assistance data can be based on the UE's indicated non-cellular positioning capabilities.

In some embodiments, these exemplary methods can also include sending, to the one or more non-cellular ranging devices, respective requests for non-cellular positioning capabilities and receiving, from the one or more non-cellular ranging devices, respective responses indicating non-cellular positioning capabilities of the respective non-cellular ranging devices. In such case, the first assistance data can be based on the indicated non-cellular positioning capabilities of the non-cellular ranging devices. In some of these embodiments, these exemplary methods can also include sending assignments of one or more of the following to the respective non-cellular ranging devices: respective device identifiers, respective non-cellular ranging signal identifiers, respective transmission schedules, and respective reception schedules.

In some embodiments, the one or more non-cellular ranging devices can be co-located with the one or more cellular RAT transmitters. Alternately, the one or more non-cellular ranging devices can be associated with the one or more cellular RAT transmitters based on known location offsets.

In various embodiments, the first assistance data can include one or more of the following:
identifiers of the respective non-cellular ranging devices;
identifiers of signals transmitted by the respective non-cellular ranging devices;
locations of the respective non-cellular ranging devices;
transmission schedules for the respective non-cellular ranging devices; and
transmission schedule for the UE.

In some of these embodiments, these exemplary methods can also include detecting non-cellular transmissions from a plurality of devices proximate to the NNF and determining the transmission schedule for the UE and/or the transmission schedules for the respective non-cellular ranging devices based on the detected non-cellular transmissions.

In some of these embodiments, these exemplary methods can also include receiving a non-cellular ranging signal transmitted by the UE, according to the transmission schedule for the UE, and retransmitting the received non-cellular ranging signal.

In various embodiments, the second assistance data can include one or more of the following:
identifiers of the respective cellular RAT transmitters;
identifiers of PRS transmitted by the respective cellular RAT transmitters;
locations of the respective cellular RAT transmitters; and
DL transmission schedules of the respective cellular RAT transmitters

In some embodiments, these exemplary methods can also include determining a position of the UE based on the first measurements and the second measurements. In some of these embodiments, these exemplary methods can also include receiving, from the one or more non-cellular ranging devices, respective third measurements of one or more non-cellular ranging signals transmitted by the UE. In such case, determining the UE's position can be further based on the third measurements.

Other embodiments include methods (e.g., procedures) for a UE configured to perform positioning measurements of cellular RAT signals and of non-cellular ranging signals.

These exemplary methods can include receiving the following information from a NNF of a wireless network: first assistance data that identifies one or more non-cellular ranging devices associated with the wireless network, and second assistance data that identifies one or more cellular RAT transmitters of the wireless network. These exemplary methods can also include performing the following measurements: first measurements of non-cellular ranging signals (e.g., UWB signals) transmitted by the one or more non-cellular ranging devices identified by the first assistance data, and second measurements of signals transmitted by the one or more cellular RAT transmitters identified by the second assistance data. These exemplary methods can also include sending the first measurements and the second measurements to the NNF.

In some embodiments, the second assistance data can be received after performing and sending the first measurements. In such case, the second assistance data can be based on the first measurements, as discussed above. In other embodiments, the first assistance data can be received after performing and sending the second measurements. In such case, the first assistance data can be based on the second measurements, as discussed above.

In some embodiments these exemplary methods can also include receiving from the NNF a request for the UE's non-cellular positioning capabilities and sending to the NNF a response indicating the UE's non-cellular positioning capabilities. In such case, the first assistance data can be based on the UE's indicated non-cellular positioning capabilities.

In some of these embodiments, the one or more non-cellular ranging devices can be co-located with the respective one or more cellular RAT transmitters. Alternately, the one or more non-cellular ranging devices can be associated with the respective one or more cellular RAT transmitters, based on respective known location offsets.

In various embodiments, the first assistance data can include any of the elements of the first assistance data summarized above for NNF embodiments. In various embodiments, the second assistance data can include any of the elements of the second assistance data summarized above for NNF embodiments.

In some of these embodiments, the second measurements are performed on non-cellular ranging signals received according to the transmission schedules for the respective non-cellular ranging devices and these exemplary methods can also include transmitting one or more further non-cellular ranging signals according to the transmission schedule for the UE.

In some embodiments, these exemplary methods can also include determining the UE's position based on the first measurements and the second measurements.

Other embodiments include methods (e.g., procedures) for a non-cellular ranging device associated a wireless network that transmits cellular RAT signals.

These exemplary methods can include receiving, from an NNF of the wireless network, a request for non-cellular positioning capabilities of the non-cellular ranging device. These exemplary methods can also include sending to the NNF a response indicating non-cellular positioning capabilities of the non-cellular ranging device.

In some embodiments, these exemplary methods can also include receiving from the NNF an assignment of one or more of the following: device identifier, non-cellular ranging signal identifier, transmission schedule, and reception schedule. In some of these embodiments, these exemplary methods can also include performing ranging measurements on first non-cellular ranging signals received from one or more UEs according to the reception schedule and transmitting one or more second non-cellular ranging signals according to the transmission schedule. In some of these embodiments, these exemplary methods can also include sending the ranging measurements to the NNF.

In some embodiments, the non-cellular ranging device can be co-located with a cellular RAT transmitter of the wireless network. Alternately, the non-cellular ranging device can be associated with the cellular RAT transmitter based on a known location offset.

Other embodiments include NNFs (e.g., eNBs, gNBs, ng-eNBs, E-SMLCs, SLPs, LMFs, etc.), UEs (e.g., wireless devices, IoT devices, etc.), and non-cellular ranging device (e.g., UEs, TRPs, MTs, etc.) configured to perform operations corresponding to any of the exemplary methods described herein. Other embodiments include non-transitory, computer-readable media storing program instructions that, when executed by processing circuitry, configure such NNFs, UEs, or non-cellular ranging devices to perform operations corresponding to any of the exemplary methods described herein.

These and other embodiments described herein can improve positioning accuracy while avoiding unnecessary interference by better provisioning and/or control of devices with non-cellular (e.g., UWB) ranging capabilities. Embodiments can facilitate improved scalability by the network performing intelligent scheduling of transmission and reception of non-cellular ranging signals by devices.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 show high-level views of exemplary 5G network architectures.

FIG. 3 shows an exemplary configuration of NR user plane (UP) and control plane (CP) protocol stacks between a UE, a gNB, and an AMF.

FIG. 4 shows an exemplary non-roaming 5G reference architecture with service-based interfaces and various network functions (NFs).

FIG. 5 shows an exemplary positioning architecture for a 5G network.

FIG. 6 shows an exemplary UWB two-way ranging procedure between two devices.

FIG. 7 shows a signal flow diagram between a network node and a UE, according to various embodiments of the present disclosure.

FIG. 8 shows a signal flow diagram between a network node and a transmission reception point (TRP), according to various embodiments of the present disclosure.

FIG. 9 shows a positioning architecture for a 5G network that is enhanced according to various embodiments of the present disclosure.

FIGS. 10-11 illustrate various arrangements for two-way ranging by UEs based on assistance from a network node, according to various embodiments of the present disclosure.

FIGS. 12-18 show various ASN.1 data structures for exemplary signaling messages, according to various embodiments of the present disclosure.

FIG. 19 is a flow diagram illustrating exemplary methods (e.g., procedures) for an NNF (e.g., eNB, gNB, ng-eNB, E-SMLC, SLP, LMF, etc.), according to various embodiments of the present disclosure.

FIG. 20 is a flow diagram illustrating exemplary methods (e.g., procedures) for a UE (e.g., wireless device, IoT device, etc. or component thereof), according to various embodiments of the present disclosure.

FIG. 21 is a flow diagram illustrating exemplary methods (e.g., procedures) for a non-cellular ranging device, (e.g., UE, TRP, MT, etc. or component thereof), according to various embodiments of the present disclosure.

FIG. 22 shows a communication system according to various embodiments of the present disclosure.

FIG. 23 shows a UE according to various embodiments of the present disclosure.

FIG. 24 shows a network node according to various embodiments of the present disclosure.

FIG. 25 shows host computing system according to various embodiments of the present disclosure.

FIG. 26 is a block diagram of a virtualization environment in which functions implemented by some embodiments of the present disclosure may be virtualized.

FIG. 27 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with “user equipment” (or “UE” for short). Some examples of a wireless device include, but are not limited to, smart phones, mobile phones, cell phones, voice over IP (VOIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Location server: As used herein, “location server” (or equivalently, “positioning node” or “positioning server”) can refer to a network node with positioning functionality, e.g., providing assistance data, requesting positioning measurements, calculating location based on positioning measurements, etc. A location server may or may not be part of a base station.
Positioning signals: As used herein, “positioning signals” may include any signal or channel to be received by the UE for performing a positioning measurement such as a DL reference signal, PRS, SSB, synchronization signal, DM-RS, CSI-RS, etc.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), and/or identifier detection/measurement (e.g., cell ID, beam ID, etc.) that are configured for a positioning method (e.g., OTDOA, E-CID, etc.). UE positioning measurements may be reported to a network node or may be used for positioning purposes by the UE.
Positioning beam: As used herein, a “positioning beam” can include any beam carrying at least one positioning signal and/or that is used for a positioning purpose such as for measurements supporting one or more positioning methods (e.g., OTDOA, AOA, etc.). A positioning beam can have its own explicit identity or can be identified through an index associated with a specific signal that the beam carries.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, there are various problems, issues, and/or difficulties that must be addressed to utilize non-cellular ranging technologies such as UWB together with other positioning techniques (e.g., based on cellular or GNSS signals) that are currently standardized by 3GPP. This is discussed in more detail after the following discussion of 5G/NR network architecture, protocols, and positioning architecture. Note that the term “non-cellular ranging” is not intended to include GNSS when used herein with respect to signals, devices, or technologies.

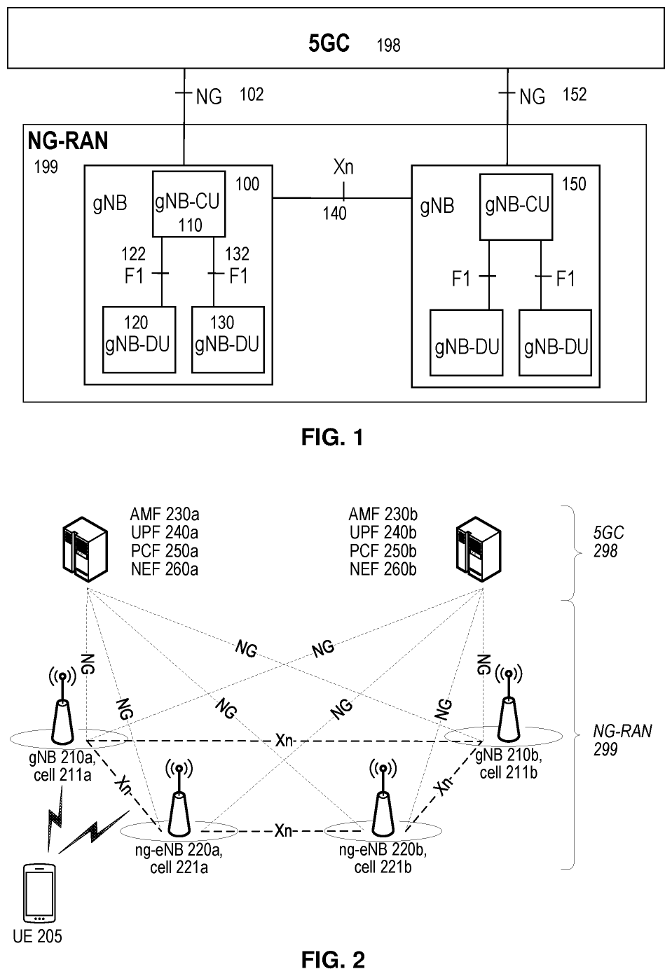

FIG. 1 illustrates an exemplary high-level view of the 5G network architecture, consisting of a Next Generation RAN (NG-RAN) 199 and a 5G Core (5GC) 198. NG-RAN 199 can include a set of gNodeB's (gNBs) connected to the 5GC via one or more NG interfaces, such as gNBs 100, 150 connected via interfaces 102, 152, respectively. In addition, the gNBs can be connected to each other via one or more Xn interfaces, such as Xn interface 140 between gNBs 100 and 150. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 1 include a central (or centralized) unit (CU or gNB-CU) and one or more distributed (or decentralized) units (DU or gNB-DU). For example, gNB 100 includes gNB-CU 110 and gNB-DUs 120 and 130. CUs (e.g., gNB-CU 110) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 122 and 132 shown in FIG. 1. The gNB-CU and connected gNB-DUs are only visible to other gNBs and the 5GC as a gNB. In other words, the F1 interface is not visible beyond gNB-CU.

FIG. 2 shows a high-level view of an exemplary 5G network architecture, including a NG-RAN 299 and a 5GC 298. As shown in the figure, NG-RAN 299 can include gNBs (e.g., 210a,b) and ng-eNBs (e.g., 220a,b) that are interconnected with each other via respective Xn interfaces. The gNBs and ng-eNBs are also connected via the NG interfaces to 5GC 298, more specifically to Access and Mobility Management Functions (AMFs, e.g., 230a,b) via respective NG-C interfaces and to User Plane Functions (UPFs, e.g., 240a,b) via respective NG-U interfaces. Moreover, the AMFs 230a,b can communicate with one or more policy control functions (PCFs, e.g., 250a,b) and network exposure functions (NEFs, e.g., 260a,b).

Each of the gNBs 210 can support the NR radio interface including frequency division duplexing (FDD), time division duplexing (TDD), or a combination thereof. Each of ng-eNBs 220 can support the fourth-generation (4G) Long-Term Evolution (LTE) radio interface. Unlike conventional LTE eNBs, however, ng-eNBs 220 connect to the 5GC via the NG interface. Each of the gNBs and ng-eNBs can serve a geographic coverage area including one more cells, such as cells 211a-b and 221a-b shown in FIG. 2. Depending on the cell in which it is located, a UE 205 can communicate with the gNB or ng-eNB serving that cell via the NR or LTE radio interface, respectively. Although FIG. 2 shows gNBs and ng-eNBs separately, it is also possible that a single NG-RAN node provides both types of functionality.

Each of the gNBs 210 can include and/or be associated with a plurality of Transmission Reception Points (TRPs). Each TRP is typically an antenna array with one or more antenna elements and is located at a specific geographical location. In this manner, a gNB associated with multiple TRPs can transmit the same or different signals from each of the TRPs. For example, a gNB can transmit different version of the same signal on multiple TRPs to a single UE. Each of the TRPs can also employ beams for transmission and reception towards the UEs served by the gNB, as discussed above.

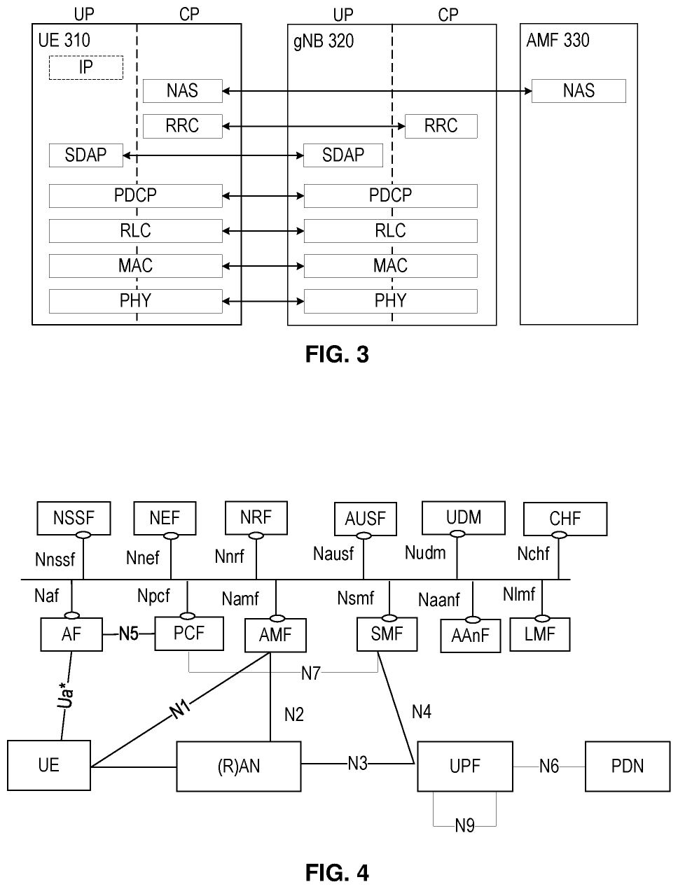

FIG. 3 shows an exemplary configuration of NR UP and CP protocol layers between a UE (310), a gNB (320), and an AMF (330), such as those shown in FIGS. 1-2. The Physical (PHY), Medium Access Control (MAC), Radio Link Control (RLC), and Packet Data Convergence Protocol (PDCP) layers between the UE and the gNB are common to UP and CP. The PDCP layer provides ciphering/deciphering, integrity protection, sequence numbering, reordering, and duplicate detection for both CP and UP. In addition, PDCP provides header compression and retransmission for UP data.

On the UP side, Internet protocol (IP) packets arrive to the PDCP layer as service data units (SDUs), and PDCP creates protocol data units (PDUs) to deliver to RLC. The Service Data Adaptation Protocol (SDAP) layer handles quality-of-service (QOS) including mapping between QoS flows and Data Radio Bearers (DRBs) and marking QoS flow identifiers (QFI) in UL and DL packets. The RLC layer transfers PDCP PDUs to the MAC through logical channels (LCH). RLC provides error detection/correction, concatenation, segmentation/reassembly, sequence numbering, reordering of data transferred to/from the upper layers. The MAC layer provides mapping between LCHs and PHY transport channels, LCH prioritization, multiplexing into or demultiplexing from transport blocks (TBs), hybrid ARQ (HARQ) error correction, and dynamic scheduling (on gNB side). The PHY layer provides transport channel services to the MAC layer and handles transfer over the NR radio interface, e.g., via modulation, coding, antenna mapping, and beam forming.

On CP side, the non-access stratum (NAS) layer is between UE and AMF and handles UE/gNB authentication, mobility management, and security control. The RRC layer sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs. RRC also performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DRX active periods (also referred to as “DRX On durations”), an RRC_IDLE UE receives SI broadcast in the cell where the UE is camping, performs measurements of neighbor cells to support cell reselection, and monitors a paging channel on PDCCH for pages from 5GC via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties similar to a “suspended” condition used in LTE.

The gNB-CUs shown in FIG. 1 can be further divided into two logical entities: gNB-CU-UP, which serves the UP and hosts PDCP; and gNB-CU-CP, which serves the CP and hosts PDCP and RRC layers. In addition, gNB-DUs hosts RLC, MAC, and PHY layers.

Another change in 5G networks (e.g., in 5GC) is that traditional peer-to-peer interfaces and protocols (e.g., those found in LTE/EPC networks) are modified by a so-called Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services. This SBA model can enable deployments to take advantage of the latest virtualization and software technologies.

The services include various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context.

FIG. 4 shows an exemplary non-roaming 5G reference architecture with service-based interfaces and various 3GPP-defined NFs within the CP. These include the following NFs, with additional details provided for those most relevant to the present disclosure:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF) with Nupf interface—supports handling of user plane traffic based on the rules received from SMF, including packet inspection and different enforcement actions (e.g., event detection and reporting).
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC).
Network Exposure Function (NEF) with Nnef interface—acts as the entry point into operator's network, by securely exposing to AFs the network capabilities and events provided by 3GPP NFs and by providing ways for the AF to securely provide information to 3GPP network.
Network Repository Function (NRF) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.

The Unified Data Management (UDM) function supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

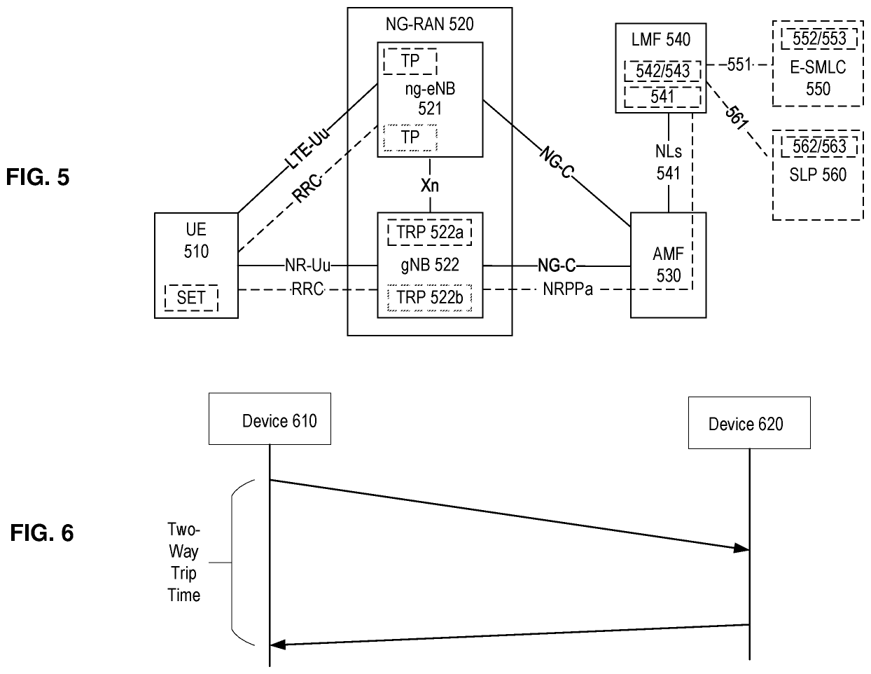

FIG. 5 is a block diagram illustrating a high-level architecture for supporting UE positioning in NR networks. NG-RAN 520 can include nodes such as gNB 522 and ng-eNB 521, similar to the architecture shown in FIG. 2. Each ng-eNB may control several transmission points (TPs), such as remote radio heads. Moreover, some TPs can be “PRS-only” for supporting positioning reference signal (PRS)-based E-UTRAN operation. Each gNB may control several transmission reception points (TRPs, e.g., 522a-b), such as discussed above.

In addition, the NG-RAN nodes communicate with an AMF 530 in the 5GC via respective NG-C interfaces (both of which may or may not be present), while AMF 530 and LMF 540 communicate via an NLs interface 541. In addition, positioning-related communication between UE 510 and the NG-RAN nodes occurs via the RRC protocol, while positioning-related communication between NG-RAN nodes and LMF occurs via an NRPPa protocol. Optionally, the LMF can also communicate with an evolved serving mobile location center (E-SMLC) 550 and a secure user plane location server (SUPL) 560 in an LTE network via communication interfaces 551 and 561, respectively. Communication interfaces 551 and 561 can utilize and/or be based on standardized protocols, proprietary protocols, or a combination thereof.

LMF 540 can also include, or be associated with, various processing circuitry 542, by which the LMF performs various operations described herein. Processing circuitry 542 can include similar types of processing circuitry as described herein in relation to other network nodes (e.g., description of FIGS. 24 and 26). LMF 540 can also include, or be associated with, a non-transitory computer-readable medium 543 storing instructions (also referred to as a computer program program) that can facilitate the operations of processing circuitry 542. Medium 543 can include similar types of computer memory as described herein in relation to other network nodes (e.g., description of FIGS. 24 and 26). Additionally, LMF 540 can include various communication interface circuitry 541 (e.g., Ethernet, optical, and/or radio transceivers) that can be used, e.g., for communication via the NLs interface. For example, communication interface circuitry 541 can be similar to other interface circuitry described herein in relation to other network nodes (e.g., description of FIGS. 24 and 26).

Similarly, E-SMLC 550 can also include, or be associated with, various processing circuitry 552, by which the E-SMLC performs various operations described herein. Processing circuitry 552 can include similar types of processing circuitry as described herein in relation to other network nodes (e.g., description of FIGS. 24 and 26). E-SMLC 550 can also include, or be associated with, a non-transitory computer-readable medium 553 storing instructions (also referred to as a computer program program) that can facilitate the operations of processing circuitry 552. Medium 553 can include similar types of computer memory as described herein in relation to other network nodes (e.g., description of FIGS. 24 and 26). E-SMLC 550 can also have communication interface circuitry that is appropriate for communicating via interface 551, which can be similar to other interface circuitry described herein in relation to other network nodes (e.g., description of FIGS. 24 and 26).

Similarly, SLP 560 can also include, or be associated with, various processing circuitry 562, by which the SLP performs various operations described herein. Processing circuitry 662 can include similar types of processing circuitry as described herein in relation to other network nodes (e.g., description of FIGS. 24 and 26). SLP 560 can also include, or be associated with, a non-transitory computer-readable medium 563 storing instructions (also referred to as a computer program program) that can facilitate the operations of processing circuitry 562. Medium 563 can include similar types of computer memory as described herein in relation to other network nodes (e.g., description of FIGS. 24 and 26). SLP 560 can also have communication interface circuitry that is appropriate for communicating via interface 561, which can be similar to other interface circuitry described herein in relation to other network nodes (e.g., description of FIGS. 24 and 26).

In a typical operation, the AMF can receive a request for a location service associated with a particular target UE from another entity (e.g., a gateway mobile location center (GMLC)), or the AMF itself can initiate some location service on behalf of a particular target UE (e.g., for an emergency call from the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

An LMF may have a signaling connection to an E-SMLC, enabling the LMF to access information from E-UTRAN, e.g., to support E-UTRA OTDOA positioning using downlink measurements obtained by a target UE. An LMF can also have a signaling connection to an SLP, the LTE entity responsible for user-plane positioning.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either the control- or user-plane protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, OTDOA positioning measurements request, and OTDOA assistance data to the UE from a positioning node (e.g., location server). LPP/NRPP are also used to deliver messages from the UE to the positioning node including, e.g., UE capability, UE measurements for UE-assisted OTDOA positioning, UE request for additional assistance data, UE configuration parameter(s) to be used to create UE-specific OTDOA assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that are to be used for OTDOA positioning measurements by the UE.

The following positioning methods are supported in NR networks:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS (A-GNSS). Measurements made by the UE on GNSS signals, supported by assistance information provided to the UE from the LMF.
DL-TDOA (Downlink Time Difference of Arrival). UE measurements of reference signal time difference (RSTD) and optionally received power (RSRP) of DL signals received from multiple TPs/TRPs, using assistance data received from the LMF. The resulting measurements are used along with other configuration information to locate the UE in relation to the neighbouring TPs.
UL-TDOA (Uplink TDOA). The UE transmits SRS and multiple reception points (RPs, which may be standalone, co-located or integrated into an gNB) at known positions measure RSTD and optionally RSRP, using assistance data received from the LMF. These measurements are forwarded to the LMF for multilateration.
Multi-RTT: The device (e.g., UE) computes UE Rx-Tx time difference and gNBs compute gNB Rx-Tx time difference. The results are combined to find the UE position based upon round trip time (RTT) calculation.
DL angle of departure (DL-AoD): gNB or LMF calculates the UE angular position based upon UE DL RSRP measurement results (e.g., of PRS transmitted by network nodes).
UL angle of arrival (UL-AoA): gNB calculates the UL AoA based upon measurements of a UE's UL SRS transmissions.
   The detailed assistance data may include information about network node locations, beam directions, etc. The assistance data can be provided to the UE via unicast or via broadcast.

As mentioned above, 3GPP Rel-15 introduced positioning based on motion (or movement) measurements by a UE, e.g., based on a motion sensor in the UE. These movement measurements typically include displacement results estimated as an ordered series of points. Motion-sensor measurements can be combined with other positioning measurements to create hybrid positioning methods. For example, motion sensor measurements can be combined A-GNSS measurements to locate a UE based on relative positioning. When GNSS signals are temporarily unavailable to the UE (e.g., in an underground tunnel), motion sensor measurements can be used to continue tracking the UE relative to the UE's last valid absolute position based on GNSS (e.g., before entering the tunnel). Motion-sensor measurements can also be combined with UE measurements of signals transmitted by an NR network, such as PRS mentioned above.

3GPP positioning standardization is ongoing for Rel-17 and includes the following objectives:
High Accuracy: mitigate the UE Rx-Tx measurement errors for Multi-RTT positioning when UE has multiple antenna panels. It is essential that UE uses the correct antenna panel to transmit UL-SRS and to perform the DL-PRS measurements.
Reduced Latency: A focus of Rel-17 is Industrial Internet of Things (IIoT) positioning. In a factory environment, there can be devices that need period localization. In such case, providing positioning configuration in advance can minimize signaling latency.
Energy reduction from network perspective: optimizing DL-PRS transmission based upon DL-PRS beam utilization. LMF can aggregate measurement reports from several UEs and based upon statistical analysis (e.g., artificial intelligence/machine learning) identify the useful beams and also beams that do not contribute to the positioning or yields to high error, low quality, etc. LMF prepares the DL-PRS activity report and provides to gNB, which can use this input to selectively turn on/off beams.
Energy reduction from UE perspective: UE positioning measurements while in RRC_IDLE and/or RRC_INACTIVE and transmission of positioning measurements using small data transmission in RRC_INACTIVE.
GNSS Integrity: introduction of key performance indicators (KPIs) for GNSS integrity such as time to alert, alert limit, and target integrity risk, as well as exchange of information (signaling) between UE and LMF to realize this.

As mentioned above, UWB is a non-cellular radio technology that uses a very low energy level for short-range, high-bandwidth communications. UWB's very narrow time-domain pulses spread energy over a large portion of the radio spectrum, i.e., an “ultra-wide bandwidth”. UWB has traditional applications in radar imaging but has more recently been used for short-range communications and high-precision ranging. For example, UWB can provide an inexpensive indoor localization solutions.

Certain aspects of UWB are specified in IEEE standard 802.15.4. In IEEE 802.15.4a networks, devices communicate by sending packet or PHY protocol data unit (PPDU). A PPDU contains a synchronization header (SHR) preamble, a PHY header (PHR), and a data field, or PHY service data unit (PSDU). The SHR preamble contains a preamble and a start-of-frame delimiter (SFD), which indicates the end of the preamble and the beginning of the PHY header. As a result, SFD can establish frame timing and its detection is important for accurate ranging.

FIG. 6 shows an exemplary two-way ranging between two devices (610 and 620) based on transmissions of non-cellular ranging signals, such as UWB. In particular, device 610 can measure a Tx-Rx time difference and device 620 can measure and Rx-Tx time difference. The combination of these measurements can be used to determine a range or distance between the devices, in a similar manner as 3GPP Multi-RTT.

Conventionally, an LMF can determine the TRPs that a UE should measure for DL positioning methods such as multi-RTT and DL-TDOA based on UE DL RSRP measurements obtained via another positioning method, such as E-CID. For example, the LMF can select TRPs for which the UE measured highest DL RSRP, subject to any geometric requirements. However, even TRPs with the highest DL RSRP measurements may not have line of sight (LOS) to the UE. Using non-LOS TRPs for positioning methods such as DL-TDOA can result in significant positioning errors, since the UE is measuring reflected signals with longer paths.

Applicants have recognized that ranging solutions can help to identify proximity of another UE or network node. However, network-based ranging technologies are not supported by 3GPP. Applicants have also recognized that short-range, non-cellular ranging technologies, such as UWB, are (or will be) supported by a large number of UEs or wireless devices, However, there is currently no framework for integrating such non-cellular ranging with other positioning techniques currently standardized by 3GPP, such as UL-TDOA, DL-TDOA, and GNSS. Furthermore, interference caused by non-cellular ranging technologies such as UWB will also increase in proportion to the number of devices using such technology, which must be addressed for successful integration with currently standardized positioning technologies.

Embodiments of the present disclosure can address these and other issues, problems, and/or challenges by novel, flexible, and efficient techniques to integrate non-cellular ranging technologies with 3GPP-specified positioning procedures. For example, the integration of a non-cellular ranging technique based on UWB with cellular RAT-specific positioning techniques such as DL-TDOA, UL-TDOA, or multi-RTT can provide hybrid positioning techniques that have certain advantages of the constituent techniques without certain disadvantages of the same.

For example, UWB solutions such as Apple AirTag and Samsung SmartTag are becoming more available in UEs and other wireless devices. Such UWB solutions conventionally perform ranging only with compatible devices (e.g., other AirTags) but can be applied according to embodiments of the present disclosure to perform positioning based on additional information provided by the network (e.g., NG-RAN, LMF, etc.). Such additional information can be obtained from RAT-specific positioning solutions such as described herein.

One advantage of such integrated or hybrid techniques is improved positioning accuracy. Another advantage is that by the network monitoring interference level due to non-cellular ranging transmissions, the network can better provision and/or control devices with non-cellular ranging technologies (e.g., UWB) to manage the level of interference, thereby avoiding unnecessary interference to the network and other devices. The network can also monitor if any non-cellular ranging device is transmitting beyond its spurious transmission levels.

Conventionally, non-cellular ranging technologies such as UWB are not scalable to a large number of devices transmitting in a particular area. Embodiments can facilitate improved scalability by the network performing intelligent scheduling of non-cellular ranging transmission and reception by devices. For example, a device's rate, frequency, or period of transmitting non-cellular ranging signals is often very low in order to fulfil average power spectral density requirements. Based on the network's knowledge of these characteristics, it can provide devices with more frequent and/or complementary positioning updates based on other techniques.

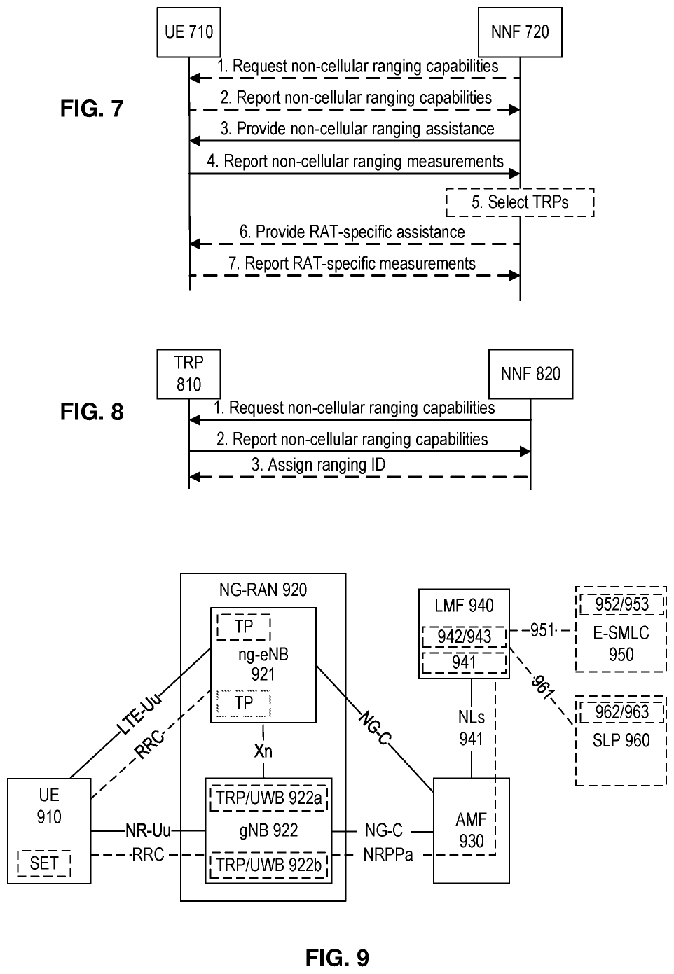

FIG. 7 shows an exemplary signaling procedure between a UE (710) and a network node or function (NNF, 720), according to various embodiments of the present disclosure. For example, NNF (720) can be any node or function (e.g., base station, gNB, LMF, etc.) that can perform the signaling shown in FIG. 7 with UE (710). Although FIG. 7 shows specific blocks in a particular order, the operations can be performed in a different order than shown and can be combined and/or divided into blocks having different functionality than shown. Optional operations are indicated by dashed lines.

In operation 1, the NNF sends the UE a request for the UE's non-cellular (e.g., UWB) ranging capabilities and the UE responds in operation 2 by reporting its non-cellular ranging capabilities as requested. If the NNF determines that the UE supports the necessary non-cellular ranging capabilities, the NNF provides non-cellular ranging assistance to the UE in operation 3. This non-cellular ranging assistance is intended to facilitate measurements by the UE on TRPs that the NNF believes to be proximate to the UE. In general, the UE will be able to detect non-cellular ranging transmissions from and/or associated with nearby TRPs and optionally perform ranging measurements based on these non-cellular ranging transmissions. The assistance may include UL transmission and/or DL reception schedules for the UE, as described in more detail below.

After performing such measurements, the UE reports them to the NNF in operation 4. Based on this input, the NNF can then configure RAT-specific positioning measurements (e.g., RTT) by the UE on the same TRPs. For example, in operation 5, the NNF can filter the non-cellular ranging measurement results to identify TRPs to be used for RAT-specific positioning (e.g., DL-TDOA, UL-TDOA, multi-RTT) by the UE. In operation 6, the NNF provides assistance data for the RAT-specific positioning to the UE, such as a list of DL PRS IDs that the UE should receive. In operation 7, the UE reports the results of its RAT-specific positioning measurements to the NNF.

An example scenario is in IIoT where non-cellular ranging transmitters to be detected/measure are at fixed locations, e.g., placed nearby TRPs. The UE needing to be localized (e.g., forklift or human fitted with helmet as device) is considered capable of both non-cellular ranging and RAT-specific positioning measurements, e.g., ranging based on UWB and TOA estimation based on DL PRS or UL SRS.

According to the arrangement shown in FIG. 7, the NNF first asks the UE whose location is to be determined to perform non-cellular ranging measurement to identify the stationary non-cellular ranging devices and thus which TRPs are in good range. Based on this information, the NNF configures the UE to perform the RAT-specific positioning technique and obtains necessary measurement results to position the UE.

In other embodiments, the order of the non-cellular ranging and RAT-specific positioning operations in FIG. 7 can be changed. For example, in operations 3-5, the NNF provides RAT-specific assistance data, receives the UE's RAT-specific positioning measurements, and selects TRPs (or associated ranging devices) for non-cellular ranging measurements by the UE. In operation 6, the NNF provides assistance data for the non-cellular ranging measurements to the UE, such as a list of ranging IDs that the UE should receive. In operation 7, the UE reports the results of its non-cellular ranging measurements to the NNF.

The NNF may also need to query TRPs to determine whether they have non-cellular ranging capabilities, such as an associated and/or integrated UWB transmitter. FIG. 8 shows an exemplary signaling procedure between a TRP (810) and a NNF (820), according to various embodiments of the present disclosure. For example, the NNF can be any node or function (e.g., base station, gNB, LMF, etc.) that can perform the signaling shown in FIG. 8 with TRP (810). In operation 1, the NNF sends the TRP a request for the TRP's non-cellular ranging capabilities and the TRP responds in operation 2 by reporting its non-cellular ranging capabilities as requested.

In some embodiments, a gNB can generate and assign IDs for non-cellular ranging devices (e.g., TRPs) when they initially connect to the NG-RAN or upon some other appropriate event. This is illustrated by FIG. 8 operation 3, which is shown as optional. The ranging device then transmits signals carrying its assigned ID in some manner that is recognizable by UEs and distinguishable from other proximate ranging devices. In case the ranging device is a TRP, as in FIG. 8, that TRP may also be associated with DL PRS ID as defined in 3GPP TS 37.355. Note that in this context, a “TRP” can also be an integrated access backhaul (IAB) node that includes a distributed unit (DU) and a mobile terminal (MT).

FIG. 9 is a block diagram illustrating a high-level architecture for hybrid non-cellular ranging/RAT-specific positioning in NR networks, according to various embodiments of the present disclosure. The architecture shown in FIG. 9 is substantially similar to the architecture shown in FIG. 5, discussed above. Entities with identical names and corresponding reference numbers (e.g., NG-RAN 920 and NG-RAN 520) are considered to be substantially identical, such that only differences from FIG. 5 are described below.

For example, gNB 922 in FIG. 9 includes TRPs 922a-b with integrated and/or associated UWB transmission and/or reception functionality necessary to support UWB ranging with UEs, such as UE 910. Additionally, gNB 922 and/or its constituent TRPs can monitor the number of proximate UWB-capable UEs (e.g., proximate to the gNB/TRP receiving antenna(s)) and the corresponding interference level caused by such UEs. This can be done, for example, by “overhearing” the UWB signals transmitted by several UEs (including UE 910) to other UEs (e.g., for UE-to-UE ranging). Alternately or additionally, if such UWB devices are also cellular RAT capable, this determination can be based on periodic registration of such devices with the cellular network (e.g., via AMF).

The gNB can identify the quality of such transmissions. The gNB can perform energy detection, attempt to perform ranging measurements, and determine quality of such measurements. It may be possible in certain cases to feed in the real measurements of the UWB devices if they are stationary. Based on this information, the gNB determine UL transmission and/or DL reception scheduling for UEs with non-cellular ranging capabilities. For example, this scheduling determination can be part of the gNB's MAC layer scheduler.

For example, the UL transmission schedule can be round robin where each non-cellular ranging UE (or other ranging device) is allocated a periodic start time and duration, such that there is little or no overlap in UL transmission durations of the respective non-cellular ranging devices in the vicinity. The gNB may also decide the DL reception as when the device may listen to some other device trying to reach to it. The gNB may then provide the UL transmission/DL reception schedules to the respective non-cellular ranging UEs as assistance data.

This is further illustrated in FIG. 10, which shows three UEs (1020-1040) performing non-cellular ranging among themselves. In operation 1, the gNB (1010) overhears these non-cellular ranging transmissions, detects energy level and quality associated with the transmissions, and determines a transmission/reception schedule for the three UEs. In operation 2, the gNB provides assistance data for UL transmission/DL reception schedule to the respective UEs, e.g., via RRC signaling.

In some cases, the gNBs may provide the determined transmission/reception schedules to an LMF via NRPPa protocol rather than sending to the UEs directly. The LMF can then provide the assistance data to the UEs via LPP dedicated signalling or request the gNB to provide the assistance data via system information (SI) broadcast.

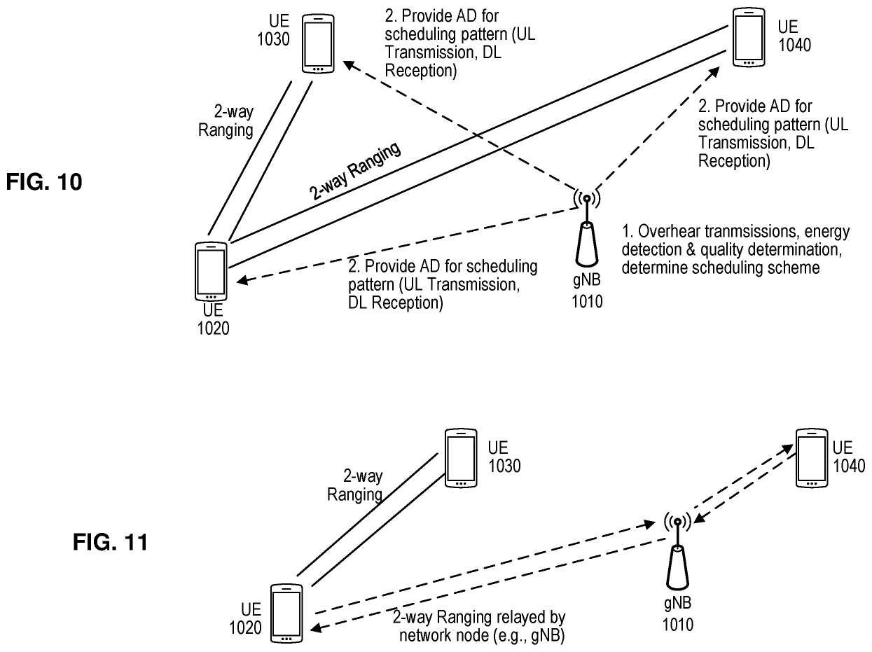

In some embodiments, a network node (e.g., gNB or TRP) can relay or amplify a non-cellular ranging signal transmitted by a UE (or other ranging device). This can be beneficial in situations where two devices trying to establish a range are separated by a distance that prevents the devices from receiving each other's signals. FIG. 11 illustrates an example of this arrangement in a similar context as FIG. 10, using the same reference numbers. In this example, one of the UEs (1020) can perform two-way ranging directly with a second UE (1030) but cannot perform two-way ranging directly with a third UE (1040). In this case, the gNB (1010) relays the two-way ranging signals between the first and third UEs.

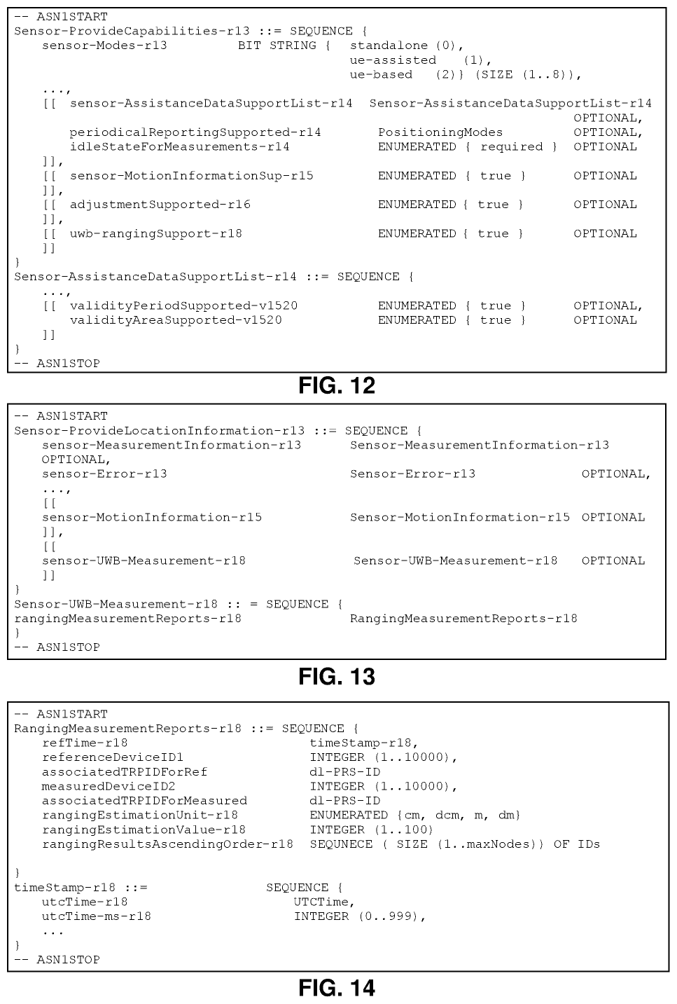

In some embodiments, the signaling shown in FIG. 7 can be provided by extending messages related to sensor-based positioning that are specified in 3GPP TS 37.355 (v16.4.0). FIG. 12 shows an ASN.1 data structure for an exemplary Sensor-ProvideCapabilities information element (IE), according to these embodiments. This IE can be used by a positioning target device (e.g., UE) to provide a location server (e.g., LMF) with the device's capabilities. It has an optional uwb-rangingSupport field, which is included with a value of “true” when the device supports non-cellular ranging capabilities based on UWB. For example, this IE can be used for, or as a part of, the message of FIG. 7 operation 2.

FIG. 13 shows an ASN.1 data structure for an exemplary Sensor-ProvideLocationInformation IE, according to these embodiments. This IE can be used by a target device to provide UWB ranging measurements to the network (e.g., LMF). For example, this IE can be used for, or as a part of, the message of FIG. 7 operation 4. It includes a Sensor-UWB-Measurement IE, which is a sequence of rangingMeasurementReports fields.

A TRP can be assigned a ranging device ID in addition to a TRP or DL PRS ID (e.g., 1 to 256). Devices that are ranging-only will not have the associated TRP ID and would be identified based upon an ID provided by network, such as IMSI or UE ID. The ranging device ID can also be a unique tag associated with the devices. Such IDs for measurement would be provided to UEs in Assistance Data.

In some embodiments, the ranging-capable UEs can perform ranging at certain intervals rather than upon request. For example, the ranging interval can be based on another cycle used for UE energy reduction (e.g., discontinuous reception/transmission), configured by the network specifically for ranging purposes, or predefined. The UE then performs ranging and reports the results to the network. For example, the UE can report results in ascending order of the node IDs or of the ranges (i.e., shortest range is reported first). The UE can report ranges in units of centimeter, decimeter, meter, or any other convenient unit.

FIG. 14 shows an ASN.1 data structure for an exemplary rangingMeasurementReports field, according to various embodiments. The time instance when the measurement was performed (refTime) is also provided along with the measurement IDs of the reference ranging device and the measured ranging devices. In some cases, the associated TRP IDs may not be known to the ranging devices but can instead be mapped by the network, e.g., ranging device ID to TRP/DL PRS ID. The ranging measurement can be between two devices, two TRPs, or between one TRP and a device.

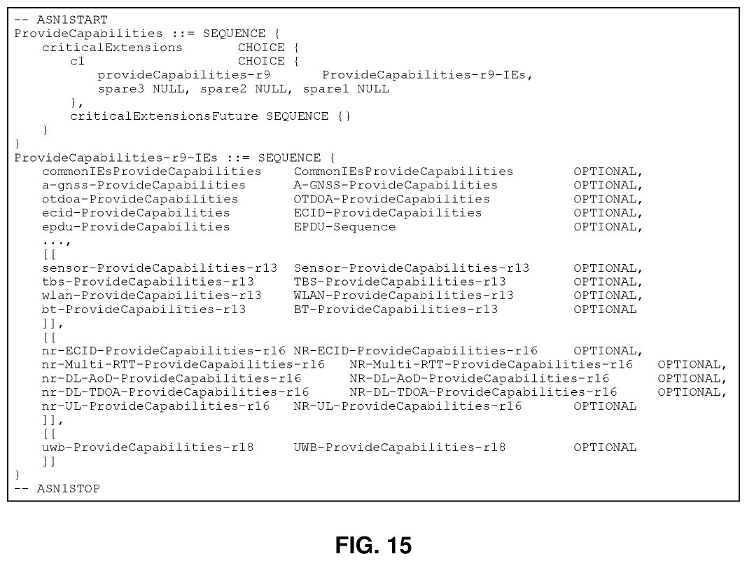

In other embodiments, rather than extending an existing positioning method (e.g., sensor-based), UWB ranging can be introduced in 3GPP specifications as another positioning method. FIGS. 15-18 show various ASN.1 data structures for signaling according to these embodiments.

In particular, FIG. 15 shows an ASN.1 data structure for an exemplary ProvideCapabilities IE, according to these embodiments. This IE can be part of an LPP message and can indicate LPP-related capabilities of the positioning target device (e.g., UE) to the positioning server (e.g., LMF). The exemplary ProvideCapabilities IE shown in FIG. 15 includes a uwb-ProvideCapabilities field that indicates the target device's capabilities for UWB ranging.

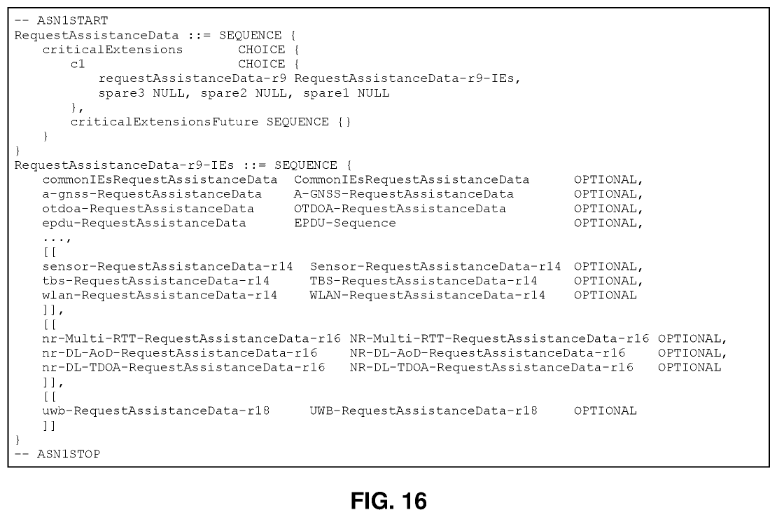

In addition, FIG. 16 shows an ASN.1 data structure for an exemplary RequestAssistance-Data IE, according to these embodiments. This IE can be part of an LPP message and can be used by the target device (e.g., UE) to request assistance data from the location server (e.g., LMF). The exemplary RequestAssistance Data IE shown in FIG. 16 includes a uwb-RequestAssistance Data field whereby the target device can request assistance data for UWB ranging.

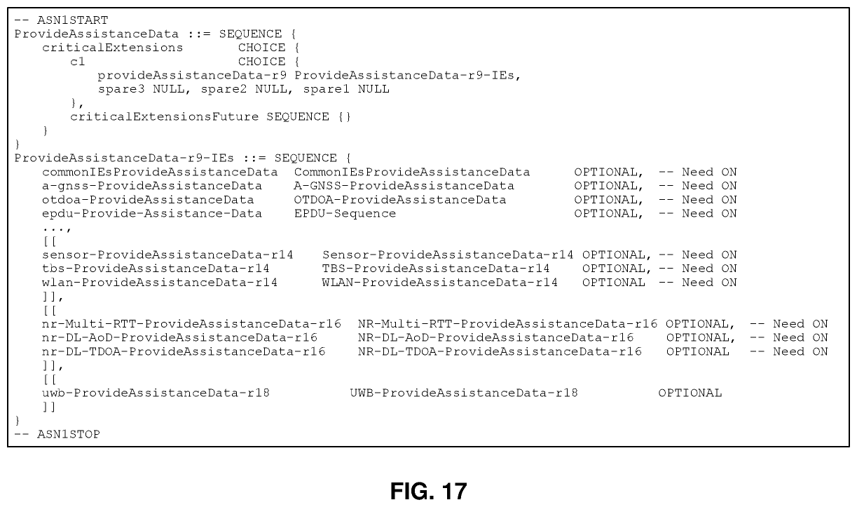

In addition, FIG. 17 shows an ASN.1 data structure for an exemplary ProvideAssistanceData IE, according to these embodiments. This IE can be part of an LPP message and can be used by the location server (e.g., LMF) to provide assistance data to the target device (e.g., UE) in response to a request from the target device (e.g., based on the IE shown in FIG. 16) or in an unsolicited manner. The exemplary RequestAssistance Data IE shown in FIG. 17 includes a uwb-ProvideAssistanceData field whereby the location server can provide assistance data for non-cellular ranging based on UWB.

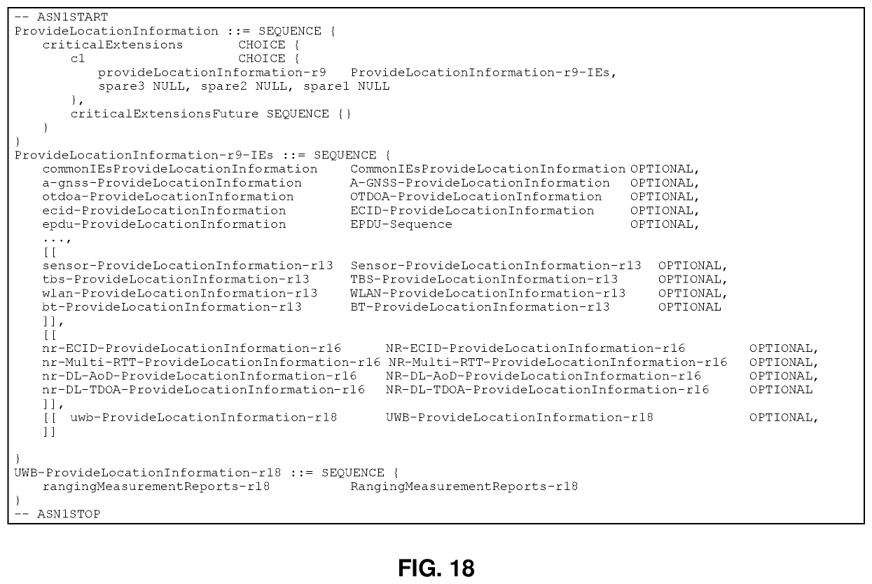

In addition, FIG. 18 shows an ASN.1 data structure for an exemplary ProvideLocationInformation IE, according to these embodiments. This IE can be part of an LPP message and can be used by the target device (e.g., UE) to provide positioning measurements or position estimates to the location server (e.g., LMF). The exemplary ProvideLocationInformation IE shown in FIG. 18 includes a uwb-ProvideLocationInformation field whereby the target device can UWB ranging measurement reports, such as a sequence of the exemplary fields shown in FIG. 14.

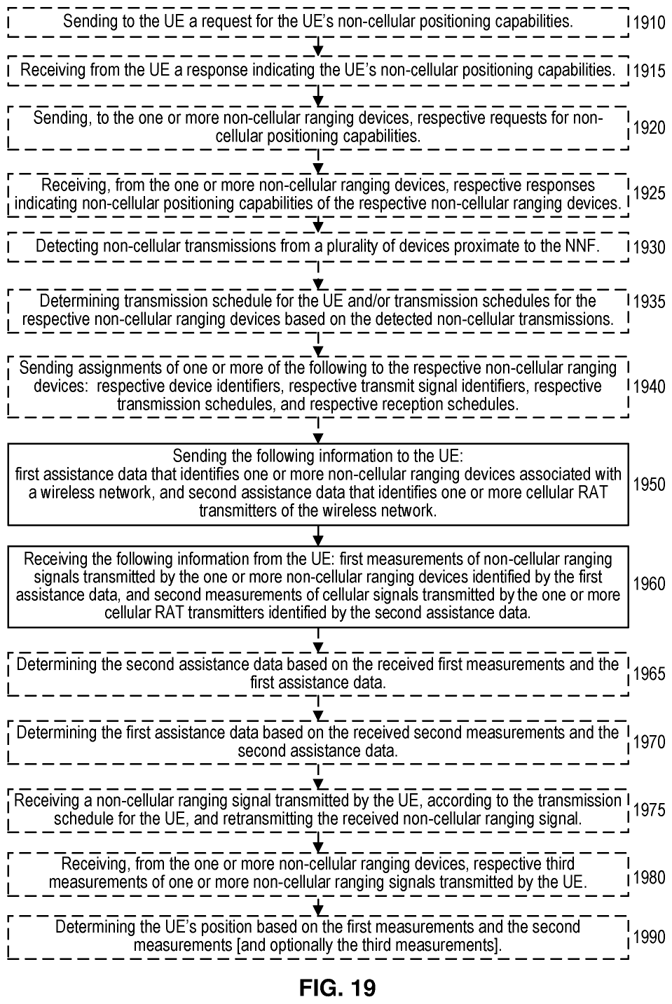

The embodiments described above can be further illustrated by the embodiments shown in FIGS. 19-21, which depict exemplary methods (e.g., procedures) for a network node or function (NNF), a UE, and a non-cellular ranging device, respectively. In other words, various features of the operations described below with reference to FIGS. 19-21 correspond to various embodiments described above. The exemplary methods shown in FIGS. 19-21 can be used cooperatively to provide various exemplary benefits described herein. Although FIGS. 19-21 shows specific blocks in particular orders, the operations of the blocks can be performed in different orders than shown and can be combined and/or divided into blocks having different functionality than shown. Optional blocks or operations are indicated by dashed lines.

In particular, FIG. 19 is a flow diagram illustrating an exemplary method (e.g., procedure) for a NNF configured to facilitate positioning of a UE based on measurements of cellular radio access technology (RAT) signals and of non-cellular ranging signals, according to various embodiments of the present disclosure. The exemplary method shown in FIG. 19 can be implemented, for example, by an NNF (e.g., eNB, gNB, ng-eNB, E-SMLC, SLP, LMF, etc.) described elsewhere herein.

The exemplary method can include the operations of block 1950, in which the NNF can send the following information to the UE: first assistance data that identifies one or more non-cellular ranging devices associated with a wireless network, and second assistance data that identifies one or more cellular RAT transmitters of the wireless network. The exemplary method can also include the operations of block 1960, in which the NNF can receive the following information from the UE: first measurements of non-cellular ranging signals (e.g., UWB signals) transmitted by the one or more non-cellular ranging devices identified by the first assistance data, and second measurements of cellular signals transmitted by the one or more cellular RAT transmitters identified by the second assistance data. Here the received “measurements” refers to measurement results.

Note that a portion of the information may be sent in block 1950 after receiving a portion of the information in block 1960, and vice versa. For example, in some embodiments, the second assistance data can be sent after receiving the first measurements and the exemplary method can also include the operations of block 1965, where the NNF can determine the second assistance data based on the received first measurements and the first assistance data.

As another example, in other embodiments, the first assistance data can be sent after receiving the second measurements and the exemplary method can also include the operations of block 1970, where the NNF can determine the first assistance data based on the received second measurements and the second assistance data.

In some embodiments the exemplary method can also include the operations of blocks 1910-1915, in which the NNF can send to the UE a request for the UE's non-cellular positioning capabilities and receive from the UE a response indicating the UE's non-cellular positioning capabilities. In such case, the first assistance data can be based on the UE's indicated non-cellular positioning capabilities.

In some embodiments, the exemplary method can also include the operations of blocks 1920-1925, in which the NNF can send, to the one or more non-cellular ranging devices, respective requests for non-cellular positioning capabilities and receive, from the one or more non-cellular ranging devices, respective responses indicating non-cellular positioning capabilities of the respective non-cellular ranging devices. In such case, the first assistance data can be based on the indicated non-cellular positioning capabilities of the non-cellular ranging devices. In some of these embodiments, the exemplary method can also include the operations of block 1940, where the NNF can send assignments of one or more of the following to the respective non-cellular ranging devices: respective device identifiers, respective non-cellular ranging signal identifiers, respective transmission schedules, and respective reception schedules.

In some embodiments, the one or more non-cellular ranging devices can be co-located with the one or more cellular RAT transmitters. Alternately, the one or more non-cellular ranging devices can be associated with the one or more cellular RAT transmitters based on known location offsets.

In various embodiments, the first assistance data can include one or more of the following:
identifiers of the respective non-cellular ranging devices;
identifiers of signals transmitted by the respective non-cellular ranging devices;
locations of the respective non-cellular ranging devices;
transmission schedules for the respective non-cellular ranging devices; and
transmission schedule for the UE.

In some of these embodiments, the exemplary method can also include the operations of blocks 1930-1935, where the NNF can detect non-cellular transmissions from a plurality of devices proximate to the NNF (e.g., to the NNF's antenna(s)) and determine the transmission schedule for the UE and/or the transmission schedules for the respective non-cellular ranging devices based on the detected non-cellular transmissions.

In some of these embodiments, the exemplary method can also include the operations of block 1975, where the NNF can receive a non-cellular ranging signal transmitted by the UE, according to the transmission schedule for the UE, and retransmit the received non-cellular ranging signal. The “relay” functionality discussed above is an example of these embodiments.

In various embodiments, the second assistance data can include one or more of the following:
identifiers of the respective cellular RAT transmitters;
identifiers of PRS transmitted by the respective cellular RAT transmitters;
locations of the respective cellular RAT transmitters; and
DL transmission schedules of the respective cellular RAT transmitters

In some embodiments, the exemplary method can also include the operations of block 1990, where the NNF can determine a position of the UE based on the first measurements and the second measurements. In some of these embodiments, the exemplary method can also include the operations of block 1980, where the NNF can receive, from the one or more non-cellular ranging devices, respective third measurements of one or more non-cellular ranging signals transmitted by the UE. In such case, determining the UE's position in block 1990 can be further based on the third measurements.

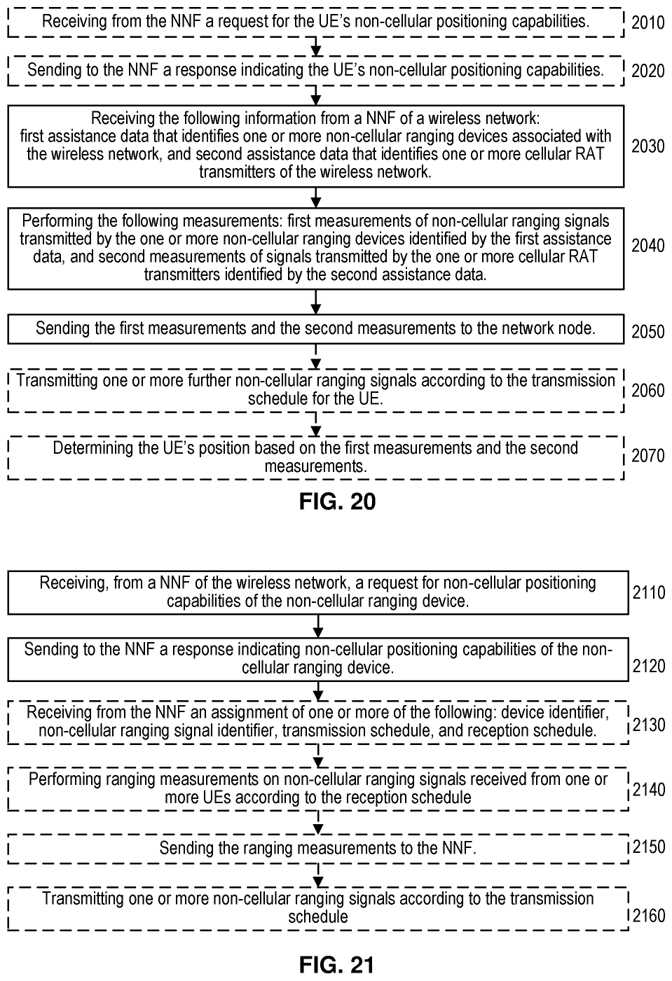

In addition, FIG. 20 is a flow diagram illustrating an exemplary method (e.g., procedure) for a UE configured to perform positioning measurements of cellular RAT signals and of non-cellular ranging signals, according to various embodiments of the present disclosure. The exemplary method shown in FIG. 20 can be implemented by a UE (e.g., wireless device, IoT device, etc. or component thereof) such as described elsewhere herein.

The exemplary method can include the operations of block 2030, in which the UE can receive the following information from a NNF of a wireless network: first assistance data that identifies one or more non-cellular ranging devices associated with the wireless network, and second assistance data that identifies one or more cellular RAT transmitters of the wireless network. The exemplary method can include the operations of block 2040, in which the UE can perform the following measurements: first measurements of non-cellular ranging signals (e.g., UWB signals) transmitted by the one or more non-cellular ranging devices identified by the first assistance data, and second measurements of signals transmitted by the one or more cellular RAT transmitters identified by the second assistance data. The exemplary method can also include the operations of block 2050, in which the UE can send the first measurements and the second measurements (i.e., the results of such measurements) to the NNF.

Note that a portion of the information may be received in block 2030 after performing a portion of the operations of blocks 2040 and/or 2050. For example, in some embodiments, the second assistance data can be received after performing and sending the first measurements. In such case, the second assistance data can be based on the first measurements, as discussed above. As another example, in other embodiments, the first assistance data can be received after performing and sending the second measurements. In such case, the first assistance data can be based on the second measurements, as discussed above.

In some embodiments the exemplary method can also include the operations of blocks 2010-2020, in which the UE can receive from the NNF a request for the UE's non-cellular positioning capabilities and send to the NNF a response indicating the UE's non-cellular positioning capabilities. In such case, the first assistance data can be based on the UE's indicated non-cellular positioning capabilities.

In some of these embodiments, the one or more non-cellular ranging devices can be co-located with the respective one or more cellular RAT transmitters. Alternately, the one or more non-cellular ranging devices can be associated with the respective one or more cellular RAT transmitters, based on respective known location offsets.

In various embodiments, the first assistance data can include one or more of the following:
identifiers of the respective non-cellular ranging devices;
identifiers of signals transmitted by the respective non-cellular ranging devices;
locations of the respective non-cellular ranging devices;
transmission schedules for the respective non-cellular ranging devices; and
transmission schedule for the UE.

In some of these embodiments, the second measurements are performed (e.g., in block 2040) on non-cellular ranging signals received according to the transmission schedules for the respective non-cellular ranging devices and the exemplary method can also include the operations of block 2060, where the UE can transmit one or more further non-cellular ranging signals according to the transmission schedule for the UE.

In various embodiments, the second assistance data can include one or more of the following:
identifiers of the respective cellular RAT transmitters;
identifiers of PRS transmitted by the respective cellular RAT transmitters;
locations of the respective cellular RAT transmitters; and
DL transmission schedules of the respective cellular RAT transmitters

In some embodiments, the exemplary method can also include the operations of block 2160, where the UE can determine its position based on the first measurements and the second measurements.

In addition, FIG. 21 is a flow diagram illustrating an exemplary method (e.g., procedure) for a non-cellular ranging device associated a wireless network that transmits cellular RAT signals, according to various embodiments of the present disclosure. The exemplary method shown in FIG. 21 can be implemented by a non-cellular ranging device (e.g., UE, TRP, MT, etc.) such as described elsewhere herein.

The exemplary method can include the operations of block 2110, where the non-cellular ranging device can receive, from an NNF of the wireless network, a request for non-cellular positioning capabilities of the non-cellular ranging device. The exemplary method can also include the operations of block 2120, where the non-cellular ranging device can send, to the NNF, a response indicating non-cellular positioning capabilities of the non-cellular ranging device.

In some embodiments, the exemplary method can also include the operations of block 2130, where the non-cellular ranging device can receive from the NNF an assignment of one or more of the following: device identifier, non-cellular ranging signal identifier, transmission schedule, and reception schedule. In some of these embodiments, the exemplary method can also include the operations of blocks 2140 and 2160, where the non-cellular ranging device can perform ranging measurements on first non-cellular ranging signals received from one or more UEs according to the reception schedule and transmit one or more second non-cellular ranging signals according to the transmission schedule. In some of these embodiments, the exemplary method can also include the operations of block 2150, where the non-cellular ranging device can send the ranging measurements (i.e., the measurement results) to the NNF.

In some embodiments, the non-cellular ranging device can be co-located with a cellular RAT transmitter of the wireless network. Alternately, the non-cellular ranging device can be associated with the cellular RAT transmitter based on a known location offset.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

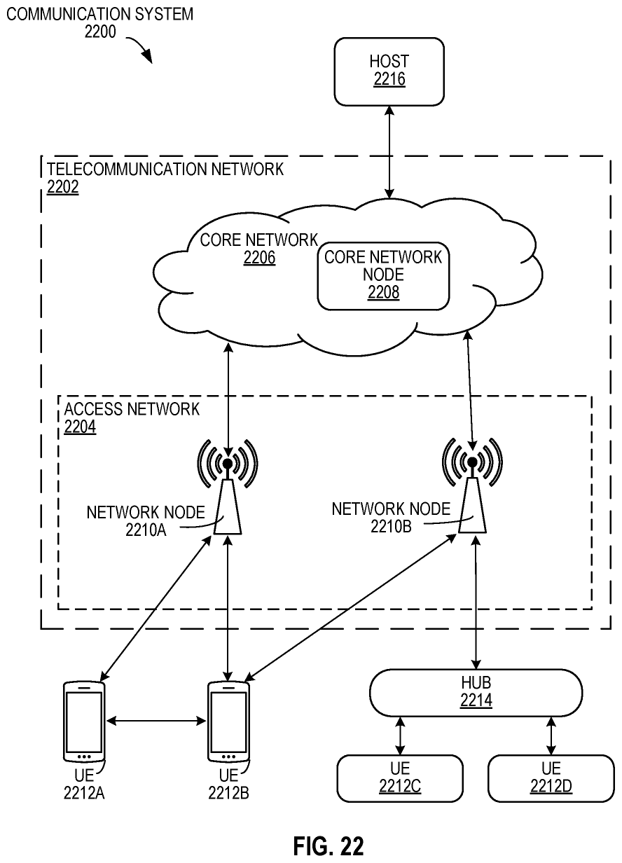

FIG. 22 shows an example of a communication system 2200 in accordance with some embodiments. In the example, the communication system 2200 includes a telecommunication network 2202 that includes an access network 2204, such as a radio access network (RAN), and a core network 2206, which includes one or more core network nodes 2208. The access network 2204 includes one or more access network nodes, such as network nodes 2210a and 2210b (one or more of which may be generally referred to as network nodes 2210), or any other similar 3GPP access node or non-3GPP access point. The network nodes 2210 facilitate direct or indirect connection of UEs, such as by connecting UEs 2212a, 2212b, 2212c, and 2212d (one or more of which may be generally referred to as UEs 2212) to the core network 2206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 2200 may include any number of wired or wireless networks, network nodes, UEs, and/or any other components or systems that may facilitate or participate in the communication of data and/or signals whether via wired or wireless connections. The communication system 2200 may include and/or interface with any type of communication, telecommunication, data, cellular, radio network, and/or other similar type of system.

The UEs 2212 may be any of a wide variety of communication devices, including wireless devices arranged, configured, and/or operable to communicate wirelessly with the network nodes 2210 and other communication devices. Similarly, the network nodes 2210 are arranged, capable, configured, and/or operable to communicate directly or indirectly with the UEs 2212 and/or with other network nodes or equipment in the telecommunication network 2202 to enable and/or provide network access, such as wireless network access, and/or to perform other functions, such as administration in the telecommunication network 2202.

In the depicted example, the core network 2206 connects the network nodes 2210 to one or more hosts, such as host 2216. These connections may be direct or indirect via one or more intermediary networks or devices. In other examples, network nodes may be directly coupled to hosts. The core network 2206 includes one more core network nodes (e.g., core network node 2208) that are structured with hardware and software components. Features of these components may be substantially similar to those described with respect to the UEs, network nodes, and/or hosts, such that the descriptions thereof are generally applicable to the corresponding components of the core network node 2208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2216 may be under the ownership or control of a service provider other than an operator or provider of the access network 2204 and/or the telecommunication network 2202, and may be operated by the service provider or on behalf of the service provider. The host 2216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2200 of FIG. 22 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2202 is a cellular network that implements 3GPP standardized features. Accordingly, the telecommunications network 2202 may support network slicing to provide different logical networks to different devices that are connected to the telecommunication network 2202. For example, the telecommunications network 2202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2212 are configured to transmit and/or receive information without direct human interaction. For instance, a UE may be designed to transmit information to the access network 2204 on a predetermined schedule, when triggered by an internal or external event, or in response to requests from the access network 2204. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 2214 communicates with the access network 2204 to facilitate indirect communication between one or more UEs (e.g., UE 2212c and/or 2212d) and network nodes (e.g., network node 2210b). In some examples, the hub 2214 may be a controller, router, content source and analytics, or any of the other communication devices described herein regarding UEs. For example, the hub 2214 may be a broadband router enabling access to the core network 2206 for the UEs. As another example, the hub 2214 may be a controller that sends commands or instructions to one or more actuators in the UEs. Commands or instructions may be received from the UEs, network nodes 2210, or by executable code, script, process, or other instructions in the hub 2214. As another example, the hub 2214 may be a data collector that acts as temporary storage for UE data and, in some embodiments, may perform analysis or other processing of the data. As another example, the hub 2214 may be a content source. For example, for a UE that is a VR headset, display, loudspeaker or other media delivery device, the hub 2214 may retrieve VR assets, video, audio, or other media or data related to sensory information via a network node, which the hub 2214 then provides to the UE either directly, after performing local processing, and/or after adding additional local content. In still another example, the hub 2214 acts as a proxy server or orchestrator for the UEs, in particular in if one or more of the UEs are low energy IoT devices.

The hub 2214 may have a constant/persistent or intermittent connection to the network node 2210b. The hub 2214 may also allow for a different communication scheme and/or schedule between the hub 2214 and UEs (e.g., UE 2212c and/or 2212d), and between the hub 2214 and the core network 2206. In other examples, the hub 2214 is connected to the core network 2206 and/or one or more UEs via a wired connection. Moreover, the hub 2214 may be configured to connect to an M2M service provider over the access network 2204 and/or to another UE over a direct connection. In some scenarios, UEs may establish a wireless connection with the network nodes 2210 while still connected via the hub 2214 via a wired or wireless connection. In some embodiments, the hub 2214 may be a dedicated hub—that is, a hub whose primary function is to route communications to/from the UEs from/to the network node 2210b. In other embodiments, the hub 2214 may be a non-dedicated hub—that is, a device which is capable of operating to route communications between the UEs and network node 2210b, but which is additionally capable of operating as a communication start and/or end point for certain data channels.

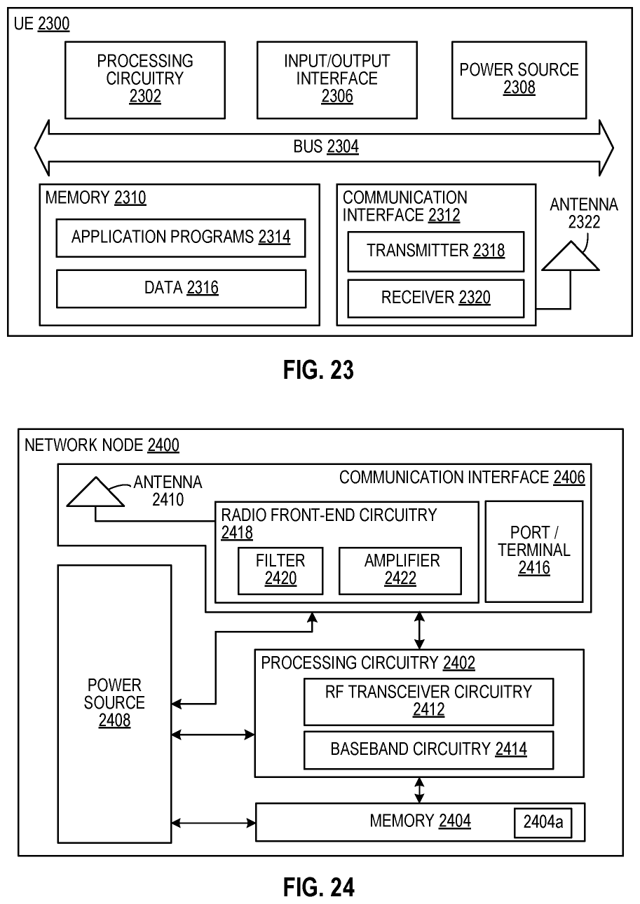

FIG. 23 shows a UE 2300 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2300 includes processing circuitry 2302 that is operatively coupled via a bus 2304 to an input/output interface 2306, a power source 2308, a memory 2310, a communication interface 2312, and/or any other component, or any combination thereof. Certain UEs may utilize all or a subset of the components shown in FIG. 23. The level of integration between the components may vary from one UE to another UE. Further, certain UEs may contain multiple instances of a component, such as multiple processors, memories, transceivers, transmitters, receivers, etc.

The processing circuitry 2302 is configured to process instructions and data and may be configured to implement any sequential state machine operative to execute instructions stored as machine-readable computer programs in the memory 2310. The processing circuitry 2302 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2302 may include multiple central processing units (CPUs).

In the example, the input/output interface 2306 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2300. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2308 is structured as a battery or battery pack. Other types of power sources, such as an external power source (e.g., an electricity outlet), photovoltaic device, or power cell, may be used. The power source 2308 may further include power circuitry for delivering power from the power source 2308 itself, and/or an external power source, to the various parts of the UE 2300 via input circuitry or an interface such as an electrical power cable. Delivering power may be, for example, for charging of the power source 2308. Power circuitry may perform any formatting, converting, or other modification to the power from the power source 2308 to make the power suitable for the respective components of the UE 2300 to which power is supplied.

The memory 2310 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2310 includes one or more application programs 2314, such as an operating system, web browser application, a widget, gadget engine, or other application, and corresponding data 2316. The memory 2310 may store, for use by the UE 2300, any of a variety of various operating systems or combinations of operating systems.

The memory 2310 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2310 may allow the UE 2300 to access instructions, application programs and the like, stored on transitory or non-transitory memory media, to off-load data, or to upload data. An article of manufacture, such as one utilizing a communication system may be tangibly embodied as or in the memory 2310, which may be or comprise a device-readable storage medium.

The processing circuitry 2302 may be configured to communicate with an access network or other network using the communication interface 2312. The communication interface 2312 may comprise one or more communication subsystems and may include or be communicatively coupled to an antenna 2322. The communication interface 2312 may include one or more transceivers used to communicate, such as by communicating with one or more remote transceivers of another device capable of wireless communication (e.g., another UE or a network node in an access network). Each transceiver may include a transmitter 2318 and/or a receiver 2320 appropriate to provide network communications (e.g., optical, electrical, frequency allocations, and so forth). Moreover, the transmitter 2318 and receiver 2320 may be coupled to one or more antennas (e.g., antenna 2322) and may share circuit components, software or firmware, or alternatively be implemented separately.

In the illustrated embodiment, communication functions of the communication interface 2312 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2312, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2300 shown in FIG. 23.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 24 shows a network node 2400 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., E-SMLCs, SUPL nodes, LMFs), and/or Minimization of Drive Tests (MDTs).

The network node 2400 includes a processing circuitry 2402, a memory 2404, a communication interface 2406, and a power source 2408. The network node 2400 may be composed of multiple physically separate components (e.g., a NodeB component and a RNC component, or a BTS component and a BSC component, etc.), which may each have their own respective components. In certain scenarios in which the network node 2400 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2400 may be configured to support multiple radio access technologies (RATs). In such embodiments, some components may be duplicated (e.g., separate memory 2404 for different RATs) and some components may be reused (e.g., a same antenna 2410 may be shared by different RATs). The network node 2400 may also include multiple sets of the various illustrated components for different wireless technologies integrated into network node 2400, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2400.

The processing circuitry 2402 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2400 components, such as the memory 2404, to provide network node 2400 functionality.

In some embodiments, the processing circuitry 2402 includes a system on a chip (SOC). In some embodiments, the processing circuitry 2402 includes one or more of radio frequency (RF) transceiver circuitry 2412 and baseband processing circuitry 2414. In some embodiments, the radio frequency (RF) transceiver circuitry 2412 and the baseband processing circuitry 2414 may be on separate chips (or sets of chips), boards, or units, such as radio units and digital units. In alternative embodiments, part or all of RF transceiver circuitry 2412 and baseband processing circuitry 2414 may be on the same chip or set of chips, boards, or units.

The memory 2404 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2402. The memory 2404 may store any suitable instructions, data, or information, including a computer program, software, an application including one or more of logic, rules, code, tables, and/or other instructions (collectively denoted computer program product 2404a) capable of being executed by the processing circuitry 2402 and utilized by the network node 2400. The memory 2404 may be used to store any calculations made by the processing circuitry 2402 and/or any data received via the communication interface 2406. In some embodiments, the processing circuitry 2402 and memory 2404 is integrated.

The communication interface 2406 is used in wired or wireless communication of signaling and/or data between a network node, access network, and/or UE. As illustrated, the communication interface 2406 comprises port(s)/terminal(s) 2416 to send and receive data, for example to and from a network over a wired connection. The communication interface 2406 also includes radio front-end circuitry 2418 that may be coupled to, or in certain embodiments a part of, the antenna 2410. Radio front-end circuitry 2418 comprises filters 2420 and amplifiers 2422. The radio front-end circuitry 2418 may be connected to an antenna 2410 and processing circuitry 2402. The radio front-end circuitry may be configured to condition signals communicated between antenna 2410 and processing circuitry 2402. The radio front-end circuitry 2418 may receive digital data that is to be sent out to other network nodes or UEs via a wireless connection. The radio front-end circuitry 2418 may convert the digital data into a radio signal having the appropriate channel and bandwidth parameters using a combination of filters 2420 and/or amplifiers 2422. The radio signal may then be transmitted via the antenna 2410. Similarly, when receiving data, the antenna 2410 may collect radio signals which are then converted into digital data by the radio front-end circuitry 2418. The digital data may be passed to the processing circuitry 2402. In other embodiments, the communication interface may comprise different components and/or different combinations of components.

In certain alternative embodiments, the network node 2400 does not include separate radio front-end circuitry 2418, instead, the processing circuitry 2402 includes radio front-end circuitry and is connected to the antenna 2410. Similarly, in some embodiments, all or some of the RF transceiver circuitry 2412 is part of the communication interface 2406. In still other embodiments, the communication interface 2406 includes one or more ports or terminals 2416, the radio front-end circuitry 2418, and the RF transceiver circuitry 2412, as part of a radio unit (not shown), and the communication interface 2406 communicates with the baseband processing circuitry 2414, which is part of a digital unit (not shown).

The antenna 2410 may include one or more antennas, or antenna arrays, configured to send and/or receive wireless signals. The antenna 2410 may be coupled to the radio front-end circuitry 2418 and may be any type of antenna capable of transmitting and receiving data and/or signals wirelessly. In certain embodiments, the antenna 2410 is separate from the network node 2400 and connectable to the network node 2400 through an interface or port.

The antenna 2410, communication interface 2406, and/or the processing circuitry 2402 may be configured to perform any receiving operations and/or certain obtaining operations described herein as being performed by the network node. Any information, data and/or signals may be received from a UE, another network node and/or any other network equipment. Similarly, the antenna 2410, the communication interface 2406, and/or the processing circuitry 2402 may be configured to perform any transmitting operations described herein as being performed by the network node. Any information, data and/or signals may be transmitted to a UE, another network node and/or any other network equipment.

The power source 2408 provides power to the various components of network node 2400 in a form suitable for the respective components (e.g., at a voltage and current level needed for each respective component). The power source 2408 may further comprise, or be coupled to, power management circuitry to supply the components of the network node 2400 with power for performing the functionality described herein. For example, the network node 2400 may be connectable to an external power source (e.g., the power grid, an electricity outlet) via an input circuitry or interface such as an electrical cable, whereby the external power source supplies power to power circuitry of the power source 2408. As a further example, the power source 2408 may comprise a source of power in the form of a battery or battery pack which is connected to, or integrated in, power circuitry. The battery may provide backup power should the external power source fail.

Embodiments of the network node 2400 may include additional components beyond those shown in FIG. 24 for providing certain aspects of the network node's functionality, including any of the functionality described herein and/or any functionality necessary to support the subject matter described herein. For example, the network node 2400 may include user interface equipment to allow input of information into the network node 2400 and to allow output of information from the network node 2400. This may allow a user to perform diagnostic, maintenance, repair, and other administrative functions for the network node 2400.

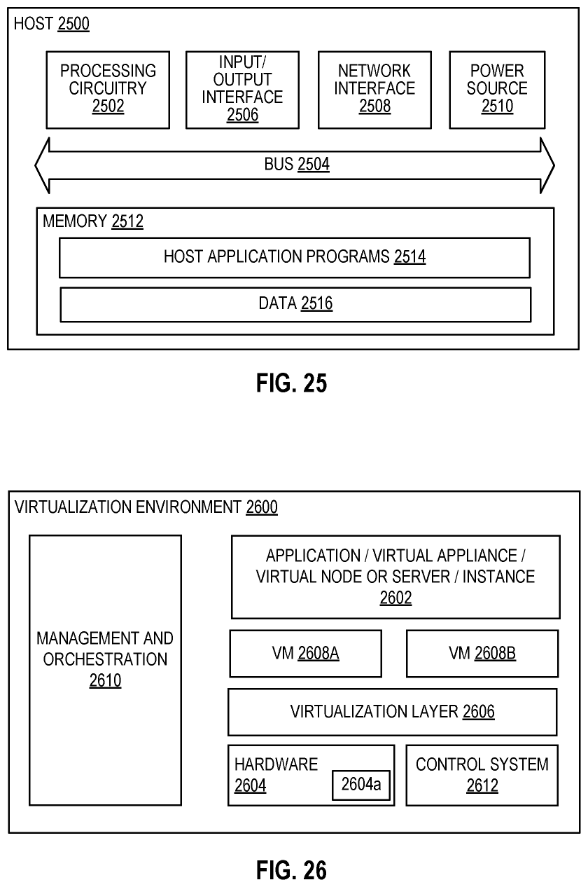

FIG. 25 is a block diagram of a host 2500, which may be an embodiment of the host 2216 of FIG. 22, in accordance with various aspects described herein. As used herein, the host 2500 may be or comprise various combinations hardware and/or software, including a standalone server, a blade server, a cloud-implemented server, a distributed server, a virtual machine, container, or processing resources in a server farm. The host 2500 may provide one or more services to one or more UEs.

The host 2500 includes processing circuitry 2502 that is operatively coupled via a bus 2504 to an input/output interface 2506, a network interface 2508, a power source 2510, and a memory 2512. Other components may be included in other embodiments. Features of these components may be substantially similar to those described with respect to the devices of previous figures, such as FIGS. 23 and 24, such that the descriptions thereof are generally applicable to the corresponding components of host 2500.

The memory 2512 may include one or more computer programs including one or more host application programs 2514 and data 2516, which may include user data, e.g., data generated by a UE for the host 2500 or data generated by the host 2500 for a UE. Embodiments of the host 2500 may utilize only a subset or all of the components shown. The host application programs 2514 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2514 may also provide for user authentication and licensing checks and may periodically report health, routes, and content availability to a central node, such as a device in or on the edge of a core network. Accordingly, the host 2500 may select and/or indicate a different host for over-the-top services for a UE. The host application programs 2514 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 26 is a block diagram illustrating a virtualization environment 2600 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2600 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2602 (which may alternatively be called software instances, virtual appliances, network functions, virtual nodes, virtual network functions, etc.) are run in the virtualization environment 2600 to implement some of the features, functions, and/or benefits of some of the embodiments disclosed herein.

Hardware 2604 includes processing circuitry, memory that stores software and/or instructions (collectively denoted computer program product 2604a) executable by hardware processing circuitry, and/or other hardware devices as described herein, such as a network interface, input/output interface, and so forth. Software may be executed by the processing circuitry to instantiate one or more virtualization layers 2606 (also referred to as hypervisors or virtual machine monitors (VMMs)), provide VMs 2608a and 2608b (one or more of which may be generally referred to as VMs 2608), and/or perform any of the functions, features and/or benefits described in relation with some embodiments described herein. The virtualization layer 2606 may present a virtual operating platform that appears like networking hardware to the VMs 2608.

The VMs 2608 comprise virtual processing, virtual memory, virtual networking or interface and virtual storage, and may be run by a corresponding virtualization layer 2606. Different embodiments of the instance of a virtual appliance 2602 may be implemented on one or more of VMs 2608, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2608 may be a software implementation of a physical machine that runs programs as if they were executing on a physical, non-virtualized machine. Each of the VMs 2608, and that part of hardware 2604 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2608 on top of the hardware 2604 and corresponds to the application 2602.

Hardware 2604 may be implemented in a standalone network node with generic or specific components. Hardware 2604 may implement some functions via virtualization. Alternatively, hardware 2604 may be part of a larger cluster of hardware (e.g., such as in a data center or CPE) where many hardware nodes work together and are managed via management and orchestration 2610, which, among others, oversees lifecycle management of applications 2602. In some embodiments, hardware 2604 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2612 which may alternatively be used for communication between hardware nodes and radio units.

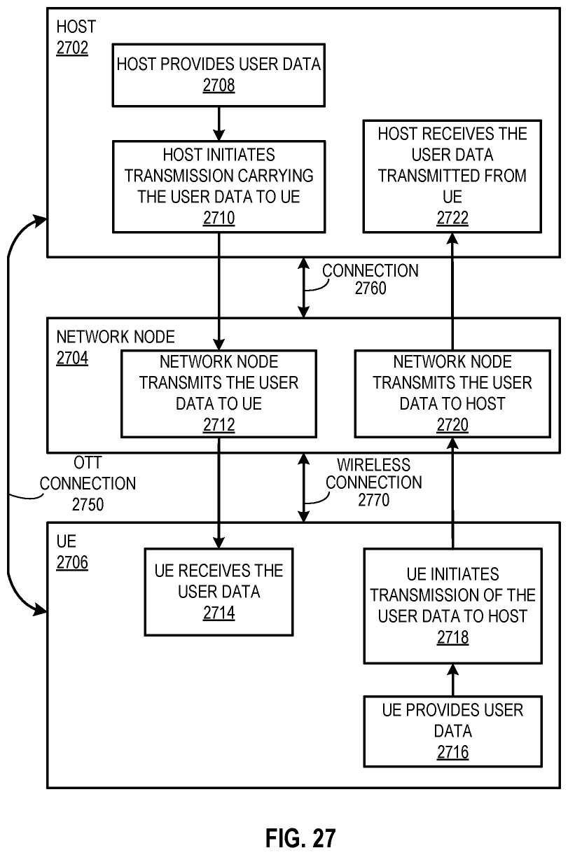

FIG. 27 shows a communication diagram of a host 2702 communicating via a network node 2704 with a UE 2706 over a partially wireless connection in accordance with some embodiments. Example implementations, in accordance with various embodiments, of the UE (such as a UE 2212a of FIG. 22 and/or UE 2300 of FIG. 23), network node (such as network node 2210a of FIG. 22 and/or network node 2400 of FIG. 24), and host (such as host 2216 of FIG. 22 and/or host 2500 of FIG. 25) discussed in the preceding paragraphs will now be described with reference to FIG. 27.

Like host 2500, embodiments of host 2702 include hardware, such as a communication interface, processing circuitry, and memory. The host 2702 also includes software, which is stored in or accessible by the host 2702 and executable by the processing circuitry. The software includes a host application that may be operable to provide a service to a remote user, such as the UE 2706 connecting via an over-the-top (OTT) connection 2750 extending between the UE 2706 and host 2702. In providing the service to the remote user, a host application may provide user data which is transmitted using the OTT connection 2750.

The network node 2704 includes hardware enabling it to communicate with the host 2702 and UE 2706. The connection 2760 may be direct or pass through a core network (like core network 2206 of FIG. 22) and/or one or more other intermediate networks, such as one or more public, private, or hosted networks. For example, an intermediate network may be a backbone network or the Internet.

The UE 2706 includes hardware and software, which is stored in or accessible by UE 2706 and executable by the UE's processing circuitry. The software includes a client application, such as a web browser or operator-specific “app” that may be operable to provide a service to a human or non-human user via UE 2706 with the support of the host 2702. In the host 2702, an executing host application may communicate with the executing client application via the OTT connection 2750 terminating at the UE 2706 and host 2702. In providing the service to the user, the UE's client application may receive request data from the host's host application and provide user data in response to the request data. The OTT connection 2750 may transfer both the request data and the user data. The UE's client application may interact with the user to generate the user data that it provides to the host application through the OTT connection 2750.

The OTT connection 2750 may extend via a connection 2760 between the host 2702 and the network node 2704 and via a wireless connection 2770 between the network node 2704 and the UE 2706 to provide the connection between the host 2702 and the UE 2706. The connection 2760 and wireless connection 2770, over which the OTT connection 2750 may be provided, have been drawn abstractly to illustrate the communication between the host 2702 and the UE 2706 via the network node 2704, without explicit reference to any intermediary devices and the precise routing of messages via these devices.

As an example of transmitting data via the OTT connection 2750, in step 2708, the host 2702 provides user data, which may be performed by executing a host application. In some embodiments, the user data is associated with a particular human user interacting with the UE 2706. In other embodiments, the user data is associated with a UE 2706 that shares data with the host 2702 without explicit human interaction. In step 2710, the host 2702 initiates a transmission carrying the user data towards the UE 2706. The host 2702 may initiate the transmission responsive to a request transmitted by the UE 2706. The request may be caused by human interaction with the UE 2706 or by operation of the client application executing on the UE 2706. The transmission may pass via the network node 2704, in accordance with the teachings of the embodiments described throughout this disclosure. Accordingly, in step 2712, the network node 2704 transmits to the UE 2706 the user data that was carried in the transmission that the host 2702 initiated, in accordance with the teachings of the embodiments described throughout this disclosure. In step 2714, the UE 2706 receives the user data carried in the transmission, which may be performed by a client application executed on the UE 2706 associated with the host application executed by the host 2702.

In some examples, the UE 2706 executes a client application which provides user data to the host 2702. The user data may be provided in reaction or response to the data received from the host 2702. Accordingly, in step 2716, the UE 2706 may provide user data, which may be performed by executing the client application. In providing the user data, the client application may further consider user input received from the user via an input/output interface of the UE 2706. Regardless of how the user data was provided, the UE 2706 initiates, in step 2718, transmission of the user data towards the host 2702 via the network node 2704. In step 2720, in accordance with the teachings of the embodiments described throughout this disclosure, the network node 2704 receives user data from the UE 2706 and initiates transmission of the received user data towards the host 2702. In step 2722, the host 2702 receives the user data carried in the transmission initiated by the UE 2706.

One or more of the various embodiments improve the performance of OTT services provided to the UE 2706 using the OTT connection 2750, in which the wireless connection 2770 forms the last segment. More precisely, the teachings of these embodiments can improve positioning accuracy while avoiding unnecessary interference by better provisioning and/or control of devices that utilized non-cellular ranging technologies such as UWB. Embodiments can facilitate improved scalability by the network performing intelligent scheduling of transmission and reception of non-cellular ranging signals by devices. In this manner, embodiments can improve location-based OTT services, thereby increasing the value of such services to end users and service providers.

In an example scenario, factory status information may be collected and analyzed by the host 2702. As another example, the host 2702 may process audio and video data which may have been retrieved from a UE for use in creating maps. As another example, the host 2702 may collect and analyze real-time data to assist in controlling vehicle congestion (e.g., controlling traffic lights). As another example, the host 2702 may store surveillance video uploaded by a UE. As another example, the host 2702 may store or control access to media content such as video, audio, VR or AR which it can broadcast, multicast or unicast to UEs. As other examples, the host 2702 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2750 between the host 2702 and UE 2706, in response to variations in the measurement results. The measurement procedure and/or the network functionality for reconfiguring the OTT connection may be implemented in software and hardware of the host 2702 and/or UE 2706. In some embodiments, sensors (not shown) may be deployed in or in association with other devices through which the OTT connection 2750 passes; the sensors may participate in the measurement procedure by supplying values of the monitored quantities exemplified above, or supplying values of other physical quantities from which software may compute or estimate the monitored quantities. The reconfiguring of the OTT connection 2750 may include message format, retransmission settings, preferred routing etc.; the reconfiguring need not directly alter the operation of the network node 2704. Such procedures and functionalities may be known and practiced in the art. In certain embodiments, measurements may involve proprietary UE signaling that facilitates measurements of throughput, propagation times, latency and the like, by the host 2702. The measurements may be implemented in that software causes messages to be transmitted, in particular empty or ‘dummy’ messages, using the OTT connection 2750 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, displaying functions, etc., such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification, drawings and exemplary embodiments thereof, can be used synonymously in certain instances, including, but not limited to, e.g., data and information. It should be understood that, while these words and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the present disclosure include, but are not limited to, the following enumerated examples.
A1. A method for a network node in a wireless network to position a user equipment (UE) based on measurements of ultrawideband (UWB) and cellular radio access technology (RAT) signals, the method comprising:
   sending the following information to the UE:
      first assistance data that identifies one or more UWB ranging devices associated with the wireless network, and
      second assistance data that identifies one or more cellular RAT transmitters associated with the wireless network; and
   receiving the following information from the UE:
      first measurements of signals transmitted by the one or more UWB ranging devices identified by the first assistance data, and
      second measurements of signals transmitted by the one or more cellular RAT transmitters identified by the second assistance data.
A2. The method of embodiment A1, wherein:
   the second assistance data is sent after receiving the first measurements; and
   the method further comprises determining the second assistance data based on the received first measurements and the first assistance data.
A3. The method of embodiment A1, wherein:
   the first assistance data is sent after receiving the second measurements; and
   the method further comprises determining the first assistance data based on the received second measurements and the second assistance data.
A4. The method of any of embodiments A1-A3, further comprising:
   sending, to the UE, a request for the UE's UWB positioning capabilities; and
   receiving, from the UE, a response indicating UWB positioning capabilities of the UE,
   wherein the first assistance data is based on the indicated UWB positioning capabilities of the UE.
A5. The method of any of embodiments A1-A4, further comprising:
   sending, to the one or more UWB ranging devices, respective requests for UWB positioning capabilities; and
   receiving, from the one or more UWB ranging devices, respective responses indicating UWB positioning capabilities of the respective UWB ranging devices,
   wherein the first assistance data is based on the indicated UWB positioning capabilities of the UWB ranging devices.
A6. The method of embodiment A5, further comprising sending assignments of one or more of the following to the respective UWB ranging devices:
   respective device identifiers,
   respective transmit signal identifiers,
   respective transmission schedules, and
   respective reception schedules.
A7. The method of any of embodiments A1-A6, wherein the one or more UWB ranging devices are one of the following with respect to the one or more cellular RAT transmitters: co-located, or associated based on known location offsets.
A8. The method of any of embodiments A1-A7, wherein the first assistance data includes one or more of the following:
   identifiers of the respective UWB ranging devices;
   identifiers of signals transmitted by the respective UWB ranging devices;
   locations of the respective UWB ranging devices;
   transmission schedules for the respective UWB ranging devices; and
   transmission schedule for the UE.
A9. The method of embodiment A8, further comprising:
   detecting UWB transmissions from a plurality of devices proximate to the network node; and
   determining the transmission schedule for the UE and/or the transmission schedules for the respective UWB ranging devices for the respective UWB ranging devices based on the detected UWB transmissions.
A10. The method of any of embodiments A8-A9, further comprising receiving a UWB signal transmitted by the UE, according to the transmission schedule for the UE, and retransmitting the received UWB signal.
A11. The method of any of embodiments A1-A10, wherein the second assistance data includes one or more of the following:
   identifiers of the respective cellular RAT transmitters;
   identifiers of positioning reference signals (PRS) transmitted by the respective cellular RAT transmitters;
   locations of the respective cellular RAT transmitters; and
   downlink (DL) transmission schedules of the respective cellular RAT transmitters
A12. The method of any of embodiments A1-A11, further comprising receiving, from the one or more UWB ranging devices, respective third measurements of one or more UWB signals transmitted by the UE.
A13. The method of any of embodiments A1-A12, further comprising determining a position of the UE based on the first measurements and the second measurements.
B1. A method for a user equipment (UE) to perform positioning measurements of ultrawideband (UWB) and cellular radio access technology (RAT) signals, the method comprising:
   receiving the following information from a network node in the wireless network:
      first assistance data that identifies one or more UWB ranging devices associated with the wireless network, and
      second assistance data that identifies one or more cellular RAT transmitters associated with the wireless network;
   performing the following measurements:
      first measurements of signals transmitted by the one or more UWB ranging devices identified by the first assistance data; and
      second measurements of signals transmitted by the one or more cellular RAT transmitters identified by the second assistance data; and
   sending the first measurements and the second measurements to the network node.
B2. The method of embodiment B1, wherein the second assistance data is received after sending the first measurements.
B3. The method of embodiment B1, wherein the first assistance data is received after sending the second measurements.
B4. The method of any of embodiments B1-B3, further comprising:
   receiving, from the network node, a request for the UE's UWB positioning capabilities; and
   sending, to the network node, a response indicating UWB positioning capabilities of the UE,
   wherein the first assistance data is based on the indicated UWB positioning capabilities of the UE.
B5. The method of any of embodiments B1-B4, wherein the one or more UWB ranging devices are one of the following with respect to the one or more cellular RAT transmitters: co-located, or associated based on known location offsets.
B6. The method of any of embodiments B1-B5, wherein the first assistance data includes one or more of the following:
   identifiers of the respective UWB ranging devices;
   identifiers of signals transmitted by the respective UWB ranging devices;
   locations of the respective UWB ranging devices;
   transmission schedules for the respective UWB ranging devices; and
   transmission schedule for the UE.
B7. The method of embodiment B6, wherein:
   the second measurements are performed on UWB signals received according to the transmission schedules for the respective UWB ranging devices; and
   the method further comprises transmitting one or more UWB signals according to the transmission schedule for the UE.
B8. The method of any of embodiments B1-B7, wherein the second assistance data includes one or more of the following:
   identifiers of the respective cellular RAT transmitters;
   identifiers of positioning reference signals (PRS) transmitted by the respective cellular RAT transmitters;
   locations of the respective cellular RAT transmitters; and
   downlink (DL) transmission schedules of the respective cellular RAT transmitters
B9. The method of any of embodiments B1-B8, further comprising determining a position of the UE based on the first measurements and the second measurements.
C1. A method for an ultrawideband (UWB) ranging device associated a wireless network that transmits cellular radio access technology (RAT) signals, the method comprising:
   receiving, from a network node in the wireless network, a request for UWB positioning capabilities; and
   sending, to the network node, a response indicating UWB positioning capabilities of the UWB ranging device.
C2. The method of embodiment C1, further comprising receiving, from the network node, an assignment of one or more of the following:
   device identifier,
   UWB transmit signal identifier,
   transmission schedule, and
   reception schedule.
C3. The method of embodiment C2, further comprising:
   performing ranging measurements on UWB signals received from one or more UEs according to the reception schedule; and
   transmitting one or more UWB signals according to the transmission schedule.
C4. The method of embodiment C3, further comprising sending the ranging measurements to the network node.
C5. The method of any of embodiments C1-C4, wherein the UWB ranging device is one of the following with respect to a cellular RAT transmitter of the wireless network: co-located, or associated based on a known location offset.
D1. A network node, in a wireless network, configured to position a user equipment (UE) based on measurements of ultrawideband (UWB) and cellular radio access technology (RAT) signals, the network node comprising:
   communication interface circuitry configured to communicate with the UE and with one or more UWB ranging devices; and
   processing circuitry operably coupled to the communication interface circuitry, whereby the communication interface circuitry and the processing circuitry are configured to perform operations corresponding to any of the methods of embodiments A1-A13.
D2. A network node, in a wireless network, configured to position a user equipment (UE) based on measurements of ultrawideband (UWB) and cellular radio access technology (RAT) signals, the network node being further configured to perform operations corresponding to any of the methods of embodiments A1-A13.
D3. A non-transitory, computer-readable medium storing computer-executable instructions that, when executed by processing circuitry of a network node configured to position a user equipment (UE) based on measurements of ultrawideband (UWB) and cellular radio access technology (RAT) signals, configure the network node to perform operations corresponding to any of the methods of embodiments A1-A13.
D4. A computer program product comprising computer-executable instructions that, when executed by processing circuitry of a network node configured to position a user equipment (UE) based on measurements of ultrawideband (UWB) and cellular radio access technology (RAT) signals, configure the network node to perform operations corresponding to any of the methods of embodiments A1-A13.
E1. A user equipment (UE) configured to perform positioning measurements of ultrawideband (UWB) and cellular radio access technology (RAT) signals, the UE comprising:
   communication interface circuitry configured to communicate with a wireless network via the UWB and cellular RAT signals; and
   processing circuitry operably coupled to the communication interface circuitry, whereby the communication interface circuitry and processing circuitry are configured to perform operations corresponding to the methods of any of embodiments B1-B9.
E2. A user equipment (UE) configured to perform positioning measurements of ultrawideband (UWB) and cellular radio access technology (RAT) signals, the UE being further configured to perform operations corresponding to the methods of any of embodiments B1-B9.
E3. A non-transitory, computer-readable medium storing computer-executable instructions that, when executed by processing circuitry of a user equipment (UE) configured to perform positioning measurements of ultrawideband (UWB) and cellular radio access technology (RAT) signals, configure the UE to perform operations corresponding to the methods of any of embodiments B1-B9.
E4. A computer program product comprising computer-executable instructions that, when executed by processing circuitry of a user equipment (UE) configured to perform positioning measurements of ultrawideband (UWB) and cellular radio access technology (RAT) signals, configure the UE to perform operations corresponding to the methods of any of embodiments B1-B9.
F1. An ultrawideband (UWB) ranging device configured for association with a wireless network that transmits cellular radio access technology (RAT) signals, the UWB ranging device comprising:
   communication interface circuitry configured to transmit and receive UWB signals and to communicate with the wireless network; and
   processing circuitry operably coupled to the communication interface circuitry, whereby the communication interface circuitry and processing circuitry are configured to perform operations corresponding to the methods of any of embodiments C1-C5.
F2. An ultrawideband (UWB) ranging device configured for association with a wireless network that transmits cellular radio access technology (RAT) signals, the UWB ranging device being further configured to perform operations corresponding to the methods of any of embodiments C1-C5.
F3. A non-transitory, computer-readable medium storing computer-executable instructions that, when executed by processing circuitry of an ultrawideband (UWB) ranging device configured for association with a wireless network that transmits cellular radio access technology (RAT) signals, configure the UWB ranging device to perform operations corresponding to the methods of any of embodiments C1-C5.
F4. A computer program product comprising computer-executable instructions that, when executed by processing circuitry of an ultrawideband (UWB) ranging device configured for association with a wireless network that transmits cellular radio access technology (RAT) signals, configure the UWB ranging device to perform operations corresponding to the methods of any of embodiments C1-C5.

1.-47. (canceled)

48. A method performed by a network node or function (NNF) configured to facilitate positioning of a user equipment (UE) based on measurements of cellular radio access technology (RAT) signals and of non-cellular ranging signals, the method comprising:
sending the following information to the UE:
first assistance data that identifies one or more non-cellular ranging devices associated with a wireless network, and
second assistance data that identifies one or more cellular RAT transmitters of the wireless network; and
receiving the following information from the UE:
first measurements of non-cellular ranging signals transmitted by the one or more non-cellular ranging devices identified by the first assistance data, and
second measurements of cellular signals transmitted by the one or more cellular RAT transmitters identified by the second assistance data.

49. The method of claim 48, wherein the non-cellular ranging signals are ultrawideband (UWB) signals.

50. The method of claim 48, wherein:
the second assistance data is sent after receiving the first measurements; and
the method further comprises determining the second assistance data based on the received first measurements and the first assistance data.

51. The method of claim 48, wherein:
the first assistance data is sent after receiving the second measurements; and
the method further comprises determining the first assistance data based on the received second measurements and the second assistance data.

52. The method of claim 48, further comprising:
sending to the UE a request for the UE's non-cellular positioning capabilities; and
receiving from the UE a response indicating the UE's non-cellular positioning,
wherein the first assistance data is based on the UE's indicated non-cellular positioning capabilities of the UE.

53. The method of claim 48, further comprising:
sending, to the one or more non-cellular ranging devices, respective requests for non-cellular positioning capabilities; and
receiving, from the one or more non-cellular ranging devices, respective responses indicating non-cellular positioning capabilities of the respective non-cellular ranging devices,
wherein the first assistance data is based on the indicated non-cellular positioning capabilities of the non-cellular ranging devices.

54. The method of claim 53, further comprising sending assignments of one or more of the following to the respective non-cellular ranging devices:
respective device identifiers,
respective non-cellular ranging signal identifiers,
respective transmission schedules, and
respective reception schedules.

55. A method performed by a user equipment (UE) configured for positioning measurements of cellular radio access technology (RAT) signals and of non-cellular ranging signals, the method comprising:
receiving the following information from a network node or function (NNF) of a wireless network:
first assistance data that identifies one or more non-cellular ranging devices associated with the wireless network, and
second assistance data that identifies one or more cellular RAT transmitters of the wireless network;
performing the following measurements:
first measurements of non-cellular ranging signals transmitted by the one or more non-cellular ranging devices identified by the first assistance data; and
second measurements of signals transmitted by the one or more cellular RAT transmitters identified by the second assistance data; and
sending the first measurements and the second measurements to the NNF.

56. The method of claim 55, wherein the non-cellular ranging signals are ultrawideband (UWB) signals.

57. The method of claim 55, wherein one of the following applies:
the second assistance data is received after sending the first measurements, or
the first assistance data is received after sending the second measurements.

58. The method of claim 55, further comprising:
receiving from the NNF a request for the UE's non-cellular positioning capabilities; and
sending to the NNF a response indicating the UE's non-cellular positioning capabilities,
wherein the first assistance data is based on the UE's indicated non-cellular positioning capabilities.

59. The method of claim 55, wherein one of the following applies:
the one or more non-cellular ranging devices are co-located with the respective one or more cellular RAT transmitters; or
the one or more non-cellular ranging devices are associated with the respective one or more cellular RAT transmitters, based on respective known location offsets.

60. The method of claim 55, wherein the first assistance data includes one or more of the following:
identifiers of the respective non-cellular ranging devices;
identifiers of signals transmitted by the respective non-cellular ranging devices;
locations of the respective non-cellular ranging devices;
transmission schedules for the respective non-cellular ranging devices; and
transmission schedule for the UE.

61. The method of claim 60, wherein:
the first measurements are performed on non-cellular ranging signals received according to the transmission schedules for the respective non-cellular ranging devices; and
the method further comprises transmitting one or more further non-cellular ranging signals according to the transmission schedule for the UE.

62. The method of claim 55, wherein the second assistance data includes one or more of the following:
identifiers of the respective cellular RAT transmitters;
identifiers of positioning reference signals (PRS) transmitted by the respective cellular RAT transmitters;
locations of the respective cellular RAT transmitters; and
downlink (DL) transmission schedules of the respective cellular RAT transmitters.

63. The method of claim 55, further comprising determining the UE's position based on the first measurements and the second measurements.

64. A network node or function (NNF) configured to facilitate positioning of a user equipment (UE) based on measurements of cellular radio access technology (RAT) signals and of non-cellular ranging signals, the NNF comprising:
communication interface circuitry configured to communicate with the UE and with one or more non-cellular ranging devices; and
processing circuitry operably coupled to the communication interface circuitry, whereby the communication interface circuitry and the processing circuitry are configured to:
send the following information to the UE:
first assistance data that identifies one or more non-cellular ranging devices associated with the wireless network, and
second assistance data that identifies one or more cellular RAT transmitters of the wireless network; and
receive the following information from the UE:
first measurements of non-cellular ranging signals transmitted by the one or more non-cellular ranging devices identified by the first assistance data, and
second measurements of cellular signals transmitted by the one or more cellular RAT transmitters identified by the second assistance data.

65. The NNF of claim 64, wherein one of the following applies:
the second assistance data is sent after receiving the first measurements, and the communication interface circuitry and the processing circuitry are further configured to determine the second assistance data based on the received first measurements and the first assistance data; or
the first assistance data is sent after receiving the second measurements, and the communication interface circuitry and the processing circuitry are further configured to determine the first assistance data based on the received second measurements and the second assistance data.

66. A user equipment (UE) configured to perform positioning measurements of cellular radio access technology (RAT) signals and of non-cellular ranging signals, the UE comprising:
communication interface circuitry configured to communicate with a wireless network and to receive the non-cellular ranging signals and the cellular RAT signals; and
processing circuitry operably coupled to the communication interface circuitry, whereby the communication interface circuitry and the processing circuitry are configured to:
receive the following information from a network node or function, NNF of a wireless network:
first assistance data that identifies one or more non-cellular ranging devices associated with the wireless network, and
second assistance data that identifies one or more cellular RAT transmitters of the wireless network;
perform the following measurements:
first measurements of non-cellular ranging signals transmitted by the one or more non-cellular ranging devices identified by the first assistance data; and
second measurements of signals transmitted by the one or more cellular RAT transmitters identified by the second assistance data; and
send the first measurements and the second measurements to the NNF.

67. The UE of claim 66, wherein one of the following applies:
the second assistance data is received after sending the first measurements, or
the first assistance data is received after sending the second measurements.
